(19) United States
(12) Patent Application Publication
(10) Pub. No.: US 2019/0289661 A1
(43) Pub. Date: Sep. 19, 2019

(54) METHOD AND APPARATUS OF HANDLING MULTIPLE RADIO RESOURCE CONTROL (RRC) PROCEDURES IN A WIRELESS COMMUNICATION SYSTEM

(71) Applicant: ASUSTek Computer Inc., Taipei City (TW)

(72) Inventor: Wei-Yu Chen, Taipei City (TW)

(21) Appl. No.: 16/354,943

(22) Filed: Mar. 15, 2019

Related U.S. Application Data
(60) Provisional application No. 62/682,305, filed on Jun. 8, 2018.
(60) Provisional application No. 62/643,972, filed on Mar. 16, 2018.

(51) Int. Cl. H04W 76/27; H04W 24/10; H04W 74/08

(52) U.S. Cl. CPC H04W 76/27; H04W 74/0866; H04W 74/0833; H04W 24/10

(57) ABSTRACT

A method and apparatus are disclosed from the perspective of a UE (User Equipment). In one embodiment, the method includes triggering a BSR (Buffer Status Report). The method further includes transmitting a preamble for a random access procedure. The method also includes receiving a random access response for responding the preamble. In addition, the method includes creating a transport block based on an uplink grant provided in the random access response, wherein the transport block cannot include both a first CCCH (Common Control Channel) SDU (Service Data Unit) and a MAC (Medium Access Control) control element for BSR even if the uplink grant indicates a transport block size larger than or equal to a sum of a size of the first CCCH SDU and a size of the MAC control element for BSR. Furthermore, the method includes transmitting the transport block based on the uplink grant provided in the random access response.

### CROSS-REFERENCE TO RELATED APPLICATIONS

The present Application claims the benefit of U.S. Provisional Patent Application Ser. No. 62/643,972 filed on Mar. 16, 2018 and U.S. Provisional Patent Application Ser. No. 62,682,305 filed on Jun. 8, 2018, the entire disclosures of which are incorporated herein in its entirety by reference.

### FIELD

This disclosure generally relates to wireless communication networks, and more particularly, to a method and apparatus of handling multiple RRC procedures in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a UE (User Equipment). In one embodiment, the method includes triggering a BSR (Buffer Status Report). The method further includes transmitting a preamble for a random access procedure. The method also includes receiving a random access response for responding the preamble. In addition, the method includes creating a transport block based on an uplink grant provided in the random access response, wherein the transport block cannot include both a first CCCH (Common Control Channel) SDU (Service Data Unit) and a MAC (Medium Access Control) control element for BSR even if the uplink grant indicates a transport block size larger than or equal to a sum of a size of the first CCCH SDU and a size of the MAC control element for BSR. Furthermore, the method includes transmitting the transport block based on the uplink grant provided in the random access response.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.2.2.1-1 of 3GPP TS 38.331 V15.0.0.

FIG. 6 is a reproduction of FIG. 9.2.2.4.1-1 of 3GPP TS 38.300 V15.0.0.

FIG. 7 is a reproduction of FIG. 7.3-1 of 3GPP 38.300 V15.0.0.

FIG. 8 is a reproduction of FIG. 9.2.2.5-1 of 3GPP TS 38.300 V15.0.0.

FIG. 9 is a diagram according to one embodiment.

FIG. 10 is a diagram according to one embodiment.

FIG. 11 is a diagram according to one embodiment.

FIG. 12 is a diagram according to one embodiment.

FIG. 13 is a diagram according to one embodiment.

FIG. 14 is a diagram according to one embodiment.

FIG. 15 is a diagram according to one embodiment.

FIG. 16 is a flow chart according to one exemplary embodiment.

FIG. 17 is a flow chart according to one exemplary embodiment.

FIG. 18 is a flow chart according to one exemplary embodiment.

FIG. 19 is a flow chart according to one exemplary embodiment.

FIG. 20 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems devices described below may be designed to support one or more standards such as the standard offered by a consortium named “3rd Generation Partnership Project” referred to herein as 3GPP, including: Chairman's note RAN2#97; Chairman's note RAN2#98; Chairman's note RAN2#99bis; Chairman's note RAN2#adhoc1801; Chairman's note RAN2#101; R2-1802735, “Remaining issues on on-demand SI request procedure”, LG Electronics Inc.; TS 38.300 V15.0.0, “NR; NR and NG-RAN Overall Description; Stage 2 (Release 15)”;TS 38.321 V15.0.0, “NR; Medium Access Control (MAC) protocol specification (Release 15)”; TS 36.331 V15.0.0, “NR; Radio Resource Control (RRC) protocol specification (Release 15)”; R2-1809109, “TP for email discussion”, LG Electronics Inc.; and R2-1808000, “Introduction of SA”, Ericsson. The standards and documents listed above are hereby expressly incorporated by reference in their entirety.

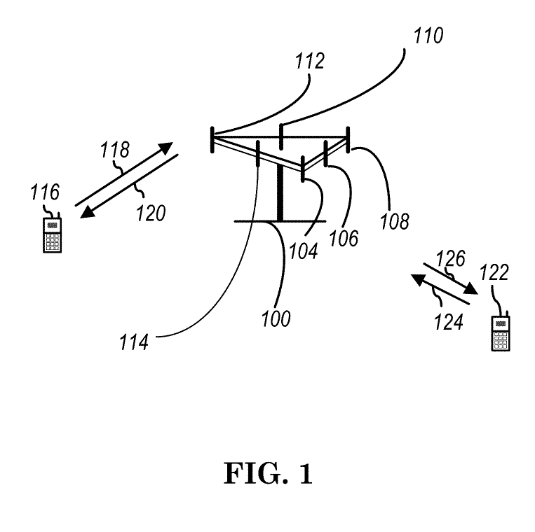

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

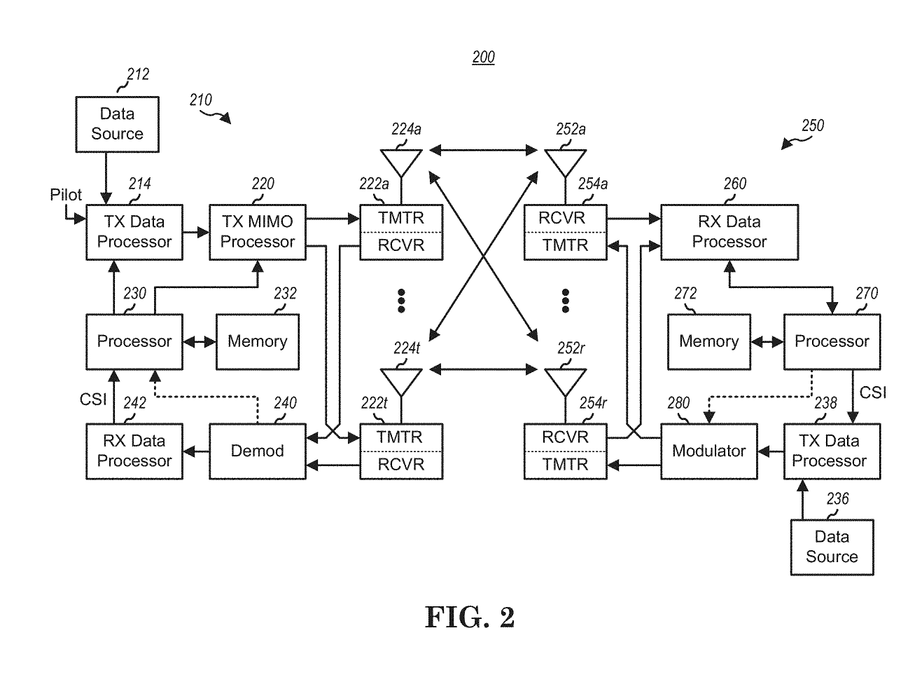

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

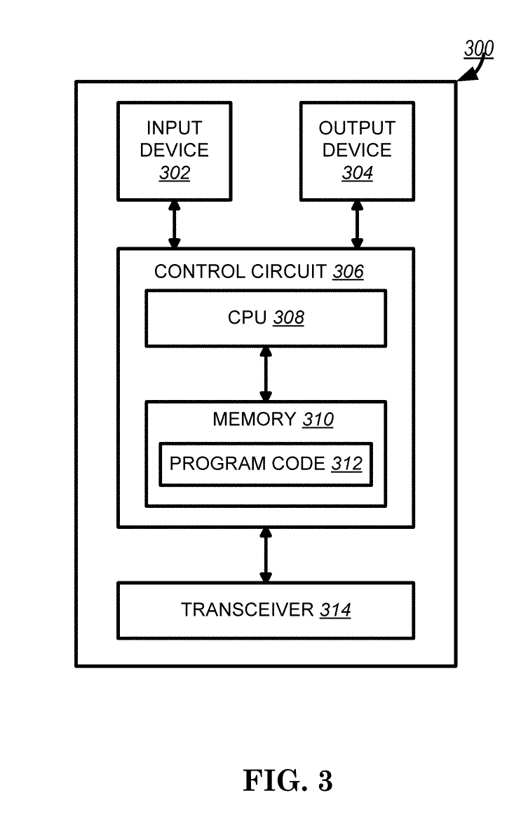

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

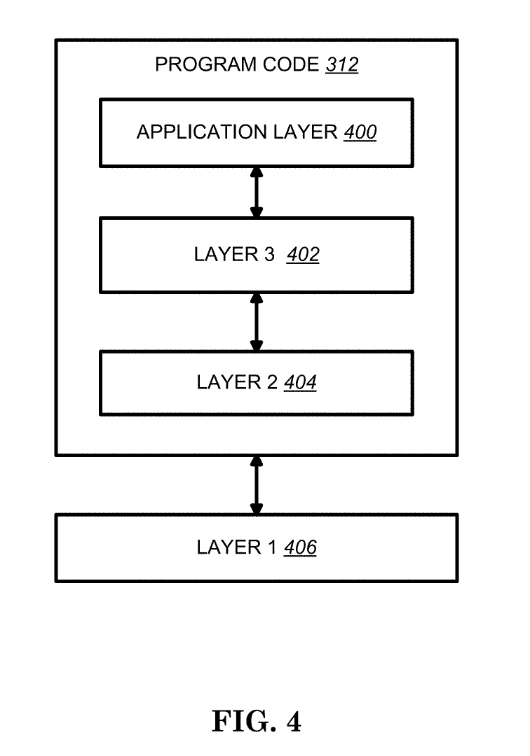

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

There are some agreements in the RAN2#97 meeting as described in the Chairman's note RAN2#97 as follows:

Agreements for common aspects of the potentials solutions for UL data in inactive (as yet there is no agreement to support UL data in inactive):

1a1:The UE AS context identifier used for uplink data transmission in RRC_INACTIVE should be the same as the one used in state transition from RRC_INACTIVE to RRC_CONNECTED.
1a2: The UE AS context is located and identified in the network via an “AS Context ID” which is allocated by the network and stored in the UE (and the network) when the UE goes to RRC_INACTIVE and is used to locate the AS context when the UE either tries to transmit small data and/or to perform a transition to RRC_CONNECTED.
1c: The UE AS Context can be stored in an “anchor”/source gNB and may be fetched to the new serving gNB when needed upon the triggering of small data transmission and/or transition from RRC_INACTIVE to RRC_CONNECTED.
1d: The network should have the ability to perform a context update when the UE sends small data in RRC_INACTIVE. That update should rely on RRC signalling and should be done in the “second” message (e.g. RRCConnectionResume or a control response message triggered by small data transmission).
2a: Small data transmission can both operate with 2-step or 4-step RACH procedure.
2b: Small data transmission uses the AS Context ID transmitted in the “first” message for contention resolution (at least when RACH is used).
3: After the “first” message with small UL data is received the network should be able to inform the UE that it should move to RRC_CONNECTED via a DL RRC message (e.g. RRCConnectionResume).
5a1: Transmission of large data is envisioned to cause a state transition to RRC_CONNECTED. The state transition is a network decision.
5b: The UE provides in the “first” message with the initial uplink data transmission all necessary information to enable the network to move the UE to RRC_CONNECTED state or to enable the network to let the UE remain in RRC_INACTIVE e.g. BSR. It is FFS if a data threshold would be applied to trigger a separate procedure for data transmission as opposed to connection resume.
6a: Subsequent small uplink data transmissions (I.e transmissions after the first UL data) in RRC_INACTIVE should be supported. FFS whether the term “subsequent small data” cover only the case of infrequent transmissions or also frequent transmissions.
6b: It is beneficial to send small downlink data to the UE with the network response message (e.g. Msg4) if user plane data are available, provided that the user plane design supports it.
8a: Small data transmission solution should be able to support at least RLC ARQ mechanism. Note: Wait for RAN1 progress regarding HARQ retransmissions.
10: Whichever solution is selected, the UE performs the tasks based on its RRC state. Further tasks specific to the data transmission procedure can be discussed if they are found necessary.
12: The “first” message with small UL data could provide information to enable the network to apply Overload control and prioritisation, if needed. It is FFS what form of overload control/prioritisation might apply in the contention based case.

There are some agreements in the RAN2#98 meeting as described in the Chairman's note RAN2#98 as follows:

### Agreements:

1 Define RRC_INACTIVE as a new RRC state in NR.
2 A UE in RRC_INACTIVE notifies the NR RAN of RAN-based location area update (RLAU) via a resume procedure when re-selecting to a cell not belonging to the configured RAN-based notification area (RNA) and periodically.

### Agreement

1 AS support for PLMN selection (i.e. providing available PLMNs to NAS) for a UE in

RRC_INACTIVE if SA2/CT1 confirm that PLMN selection is supported.

### Agreement

1 Connection resume message will include information that can at least indicate RAN area update. Inclusion of information to enable access control is not precluded.
Agreements for paging in inactive using DRX (excludes eDRX, if supported)
1: Use the same paging occasion calculation mechanism for UEs in inactive as for UEs in idle.
2: The same input derived from CN UE ID and the same calculation equation is used to calculate the paging occasion for RAN-initiated paging and CN-initiated paging.
3: The gNB needs to know the input derived from CN UE ID to be used in the calculation and CN UE specific DRX cycle from the NG core.
4: A UE in inactive can be configured with a UE specific RAN DRX cycle over dedicated signalling.
5:The UE uses the shortest of the CN UE specific DRX cycle and the cell broadcasted DRX cycle and the RAN DRX cycle. All the DRX cycle values must be multiples of each other.
6:UE specific RAN DRX cycle is released when the UE enters idle states.
7 UE specific RAN DRX cycle continues to be used when the UE moves to one new cell in the RNA area in inactive state.

### Agreements

RAN2 aims that the 5G AC mechanism for a UE in RRC_IDLE is applicable to a UE in RRC_INACTIVE.
FFS if any aspects may not be applicable or may need to be changed for RRC_INACTIVE relative to RRC_IDLE (to be addressed by both CT1 and RAN2).
2 RAN2 aims to define the 5G AC mechanism for a UE in RRC_CONNECTED. Details FFS
3 UE NAS provides the access category information to UE RRC at least for RRC_IDLE FFS for RRC_INACTIVE
4 Connection Request will include some information to enable the gNB to decide whether to reject the connection request
FFS whether the information that is included is e.g. provided by NAS, derived from the AC, etc

### FFS for RRC_INACTIVE

There are some agreements in the RAN2#99bis meeting as described in the Chairman's note RAN2#99bis as follows:

### Agreements

1 A UE in INACTIVE, trying to resume an RRC connection, can receive MSG4 sent over SRB0 (without Integrity protection) to move the UE back into INACTIVE (i.e. rejected with wait timer).
2 INACTIVE related parameters/configuration should not be updated by a MSG4 sent over SRB0 (as it is a non-protected message).
3 A UE in INACTIVE, trying to resume an RRC connection, can receive MSG4 sent over SRB1 with at least integrity protection to move the UE back into INACTIVE (i.e. not rejected). (RNA update use case)
4 The MSG4 (i.e. not rejected) of agreement 3 can configure at least the same parameters as can be configured by the message that moves the UE to inactive (e.g. I-RNTI, RNA, RAN DRX cycle, periodic RNAU timer, redirect carrier frequency, for inactive mode mobility control information or reselection priority information). (security framework are to be discussed independently)
5 A UE in INACTIVE, trying to resume the RRC connection, canreceive MSG4 sent over SRB1 with at least integrity protection to move the UE into IDLE.
5.1 This MSG4 (i.e. SRB1 release to IDLE) can carry same information as RRC Connection release kind of message (e.g. priority, redirect information, idle mode mobility control information, cause and idle mode re-selection information).
UE in INACTIVE, trying to resume an RRC connection, cannot receive MSG4 sent over SRB0 (without Integrity protection) to move the UE into IDLE to stay in IDLE (i.e. not precluding use of fallback to RRC Connection Establishment).

There are some agreements in the RAN2#adhoc1801 meeting as described in the Chairman's note RAN2#adhoc1801 as follows:

### Agreement

1 If the dedicated reselection parameters are not provided when entering RRC_INACTIVE and RRC_IDLE, the UE applies cell reselection parameters received from system information.

### Agreements:

1Idle mode/inactive mode DRX cycle configuration in NR should take the default DRX cycle parameter in LTE as baseline.
2 The maximum idle/inactive mode DRX value in NR should be 2.56s.

There are some agreements in the RAN2#101 meeting as described in the Chairman's note RAN2#101 as follows:

### Agreements

1: For cell lists approach, RNA contains cells that belong to the same PLMN
2: maximum number of cells in RAN notification area is 32;
3: NR Cell Identity (36 bits) are used as cell id for cell list approach;
4: maximum RAN Area IDs configured in one RNA is [32]
5: RANAC size should [6]bits. (send LS to RAN3)
6: For one cell, only 1 RANAC can be broadcasted. A single RANAC is common for all PLMNs sharing the RAN.
7 RANAC is optional field in SIB1.
8 maximum 16 TAIs can be configured in one RAN notification area;
9 ASN.1 is agreed as a baseline.
10 RNA is mandatory configured for the inactive UEs for Rel-15; (May be re-discussed after the discussion of the interaction between RANU and TAU)

### Agreements

1: RAN2 to confirm that moving the UE to RRC_CONNECTED or RRC_IDLE in response to RNAU is allowed and up to eNB decision.
2: RAN2 to agree that the UE context is transferred to the serving gNB when it receives from the UE an RNAU due to change of RNA.
3: If resume procedure (including RNAU procedure) fails, the UE move to RRC_IDLE and indicates to NAS to perform NAS recovery
3a Resume procedure is protected by a timer (similar to T300 for connection establishment procedure). UE consider resume failure upon timer expiry.
For RAN paging, I-RNTI is used as the UE identity in the paging record.
The UE initiates RRC Connection Resume procedure upon receiving RAN paging.
RAN2 to confirm that the UE moves to RRC IDLE and informs NAS when it receives a CN paging in RRC_INACTIVE state.
Same paging message is used for RAN paging as Idle paging.
RAN paging is not used to move UEs from RRC_INACTIVE to RRC_IDLE.

### Agreement

1: Inter-RAT re-selection from NR INACTIVE to an LTE/5GC cell, UE moves to Idle and informs NAS to trigger NAS recovery.
Working assumption:
1 NCC provided when the connection is suspended
2: New key is derived based on the NCC received in the suspend message and used for the calculation of MAC-I in MSG3.

### Agreements

Msg3 is protected and verification is performed by the last serving gNB before UE context is transferred to another network node.
FFS Whether it may also be possible that the target gNB can verify the Msg3 in some cases. =>Include in previous offline whether Msg 3 is protected with old key or new.
Msg3 includes a MAC-I in the RRC message as in LTE
FFS Inputs used for MAC-I calculation in order to possibly address the replay attack concern from SA3.

### Agreements

1: Assuming no limitation on MSG3 size based on the feedback from RAN1, I-RNTI size is 52bits, including node ID and UE identifier.
2: Internal structure is transparent to the UE and internal structure can be discussed by RAN3.
Agreements for NR only
1: At least 8 and preferably 16 (or more) cause value to be included in MSG 3. To be finalised when the we have received input from RAN1 on MSG3 size and have a full picture of the content of MSG3.
2: At least the following LTE establishment cause values are reused for NR: emergency, highPriorityAccess, mt-Access, mo-Signalling, mo-Data, mo-VoiceCall-v1280
FFS Whether the LTE cause delayTolerantAccess-v1020 is also available in NR.
3: AS triggered event, RNA update shall be controlled by ACB
FFS Which access category is used for an RNA update
4: On demand SI request shall not be controlled by ACB.

### Agreements

1 Previous agreement that SI request is an RC message is confirmed.
2 SI request and RRC connection request are 2 independent procedures.
3 UE ID is not included in MSG3
4 For contention resolution UE MAC performs same as other cases and check the contention resolution MAC CE against the transmitted request (common RACH procedure in MAC)

The network can initiate multiple RRC (Radio Resource Control) procedures in parallel as described in 3GPP TS 38.331 as follows:

### 5.1.2 General Requirements

The UE shall:
1>process the received messages in order of reception by RRC, i.e. the processing of a message shall be completed before starting the processing of a subsequent message;
NOTE 1: A subsequent procedure may be initiated prior to receiving the UE's response of a previously initiated procedure.

3GPP R2-1802735 includes the following discussion about how to accelerate RRC connection resume or establishment:

We think that there are two options to avoid this problem:
Option 1: If RRC triggers state transition procedure such as RRC Connection Establishment or RRC Connection Resume, UE stops ongoing RACH procedure for SI request.
Option 2: New MAC CE is defined for SI request in Msg3, instead of RRC signaling.
   In Option 1, if RRC triggers state transition procedure such as RRC Connection Establishment or RRC Connection Resume, but if RACH procedure for SI request is ongoing, UE stops ongoing RACH procedure for SI request and then triggers new RACH procedure for state transition.
   Meanwhile, Option 2 is different than the previous agreement. However, it is beneficial to easily solve this problem because CCCH message has a higher priority than a MAC CE in MAC. In addition, since MAC CE and RACH preamble are terminated in DU (while RRC message is terminated in CU), SI request procedure based on Msg3 can be aligned with SI request procedure based on Msg1 in the network.
   Accordingly, we propose one of the options above to avoid the problem.
   Proposal 10: We propose to consider one of the following options to avoid delayed state transition caused by SI request transmission:
Option 1: If RRC triggers state transition procedure such as RRC Connection Establishment or RRC Connection Resume, UE stops ongoing RACH procedure for SI request.
Option 2: New MAC CE is defined for SI request in Msg3, instead of RRC signaling.

3GPP 38.321 provides the following discussion about how to accelerate RRC connection resume or establishment:

### 5.1 Random Access Procedure

### 5.1.1 Random Access Procedure Initialization

The Random Access procedure described in this subclause is initiated by a PDCCH order, by the MAC entity itself, by beam failure indication from lower layer, or by RRC for the events in accordance with TS 38.300 [2]. There is only one Random Access procedure ongoing at any point in time in a MAC entity. The Random Access procedure on an SCell other than PSCell shall only be initiated by a PDCCH order with ra-Preamblelndex different from 0b000000.
NOTE 1: If the MAC entity receives a request for a new Random Access procedure while another is already ongoing in the MAC entity, it is up to UE implementation whether to continue with the ongoing procedure or start with the new procedure (e.g. for SI request).
   RRC configures the following parameters for the Random Access procedure:
prach-Configindex: the available set of PRACH resources for the transmission of the Random Access Preamble;
ra-PreamblelnitialReceivedTargetPower: initial preamble power;
rsrp-ThresholdSSB, csirs-dedicatedRACH-Threshold, and sul-RSRP-Threshold: an RSRP threshold for the selection of the SS block and corresponding PRACH resource;
ra-PreamblePowerRampingStep: the power-ramping factor;
ra-Preamblelndex: Random Access Preamble;
ra-PreambleTx-Max: the maximum number of preamble transmission;
if SSBs are mapped to preambles:
   startIndexRA-PreambleGroupA, numberOfRA-Preambles, and numberOfRA-PreamblesGroupA for each SSB in each group (SpCell only).
else:
startIndexRA-PreambleGroupA, numberOfRA-Preambles, and numberOfRA-PreamblesGroupA in each group (SpCell only).
If numberOfRA-PreamblesGroupA is equal to numberOfRA-Preambles, there is no Random Access Preambles group B.
   The preambles in Random Access Preamble group A are the preambles startIndexRA-PreambleGroupA to startIndexRA-PreambleGroupA+numberOfRA-PreamblesGroupA−1;
   The preambles in Random Access Preamble group B, if exists, are the preambles startIndexRA-PreambleGroupA+numberOfRA-PreamblesGroupA to startIndexRA-PreambleGroupA+numberOfRA-Preambles−1.
      NOTE 2: if random Access Preambles group B is supported by the cell and SSBs are mapped to preambles, random access preambles group B is included in each SSB.
if Random Access Preambles group B exists:
   ra-Msg3SizeGroupA (per cell): the threshold to determine the groups of Random Access Preambles.
the set of Random Access Preambles for SI request and corresponding PRACH resource(s), if any;
the set of Random Access Preambles for beam failure recovery request and corresponding PRACH resource(s), if any;
ra-Response Window: the time window to monitor RA response(s);
bfr-ResponseWindow: the time window to monitor response(s) on beam failure recovery request;
ra-ContentionResolutionTimer: the Contention Resolution Timer (SpCell only).
   In addition, the following information for related Serving Cell is assumed to be available for UEs:
if Random Access Preambles group B exists:
   if the MAC Entity is configured with supplementaryUplink, and SUL carrier is selected for performing Random Access Procedure:
      P_{CMAXc_SUL}: the configured UE transmitted power of the SUL carrier.
   else:
      P_{CMAX,c}: the configured UE transmitted power of the Serving Cell performing the Random Access Procedure.
         The following UE variables are used for the Random Access procedure:
PREAMBLE_INDEX;
PREAMBLE_TRANSMISSION_COUNTER;
PREAMBLE_POWER_RAMPING_COUNTER;
PREAMBLE_RECEIVED_TARGET_POWER;
PREAMBLE_BACKOFF;
PCMAX;
TEMPORARY_C-RNTI.
   When the Random Access procedure is initiated, the MAC entity shall: 1>flush the Msg3 buffer;
1>set the PREAMBLE_TRANSMISSION_COUNTER to 1;
1>set the PREAMBLE_POWER_RAMPING_COUNTER to 1;
1>set the PREAMBLE BACKOFF to 0 ms;
1>if the carrier to use for the Random Access procedure is explicitly signalled:
   2>select the signalled carrier for performing Random Access procedure.
1>else if the carrier to use for the Random Access procedure is not explicitly signalled; and
1>if the cell for the Random Access procedure is configured with supplementaryUplink; and
1>if the RSRP of the downlink pathloss reference is less than sul-RSRP-Threshold:
   2>select the SUL carrier for performing Random Access procedure;
   2>set the PCMAX to P_{CMAX,c_SUL}.
1>else:
   2>select the normal carrier for performing Random Access procedure;
   2>set the PCMAX to P_{CMAX,c}.
1>perform the Random Access Resource selection procedure (see subclause 5.1.2).

### 5.1.2 Random Access Resource Selection

The MAC entity shall:
1>if the Random Access procedure was initiated by a beam failure indication from lower layer; and

1 1>if the contention free PRACH resources for beam failure recovery request associated with any of the SS blocks and/or CSI-RSs have been explicitly provided by RRC; and
1>if at least one of the SS blocks with SS-RSRP above rsrp-ThresholdSSB amongst the associated SS blocks or the CSI-RSs with CSI-RSRP above csirs-dedicatedRACH-Threshold amongst the associated CSI-RSs is available:
   2>select an SS block with SS-RSRP above rsrp-ThresholdSSB amongst the associated SS blocks or a CSI-RS with CSI-RSRP above csirs-dedicatedRACH-Threshold amongst the associated CSI-RSs;
   2>set the PREAMBLE_INDEX to a ra-Preambleindex corresponding to the selected SS block or CSI-RS from the set of Random Access Preambles for beam failure recovery request.
1>else if the ra-Preambleindex has been explicitly provided by either PDCCH or RRC; and
1>if the ra-Preambleindex is not 0b000000; and
1>if contention free PRACH resource associated with SS blocks or CSI-RS have not been explicitly provided by RRC:
   2>set the PREAMBLE_INDEX to the signalled ra-Preamblelndex.
1>else if the contention free PRACH resources associated with SS blocks have been explicitly provided by RRC and at least one SS block with SS-RSRP above rsrp-ThresholdSSB amongst the associated SS blocks is available:
   2>select an SS block with SS-RSRP above rsrp-ThresholdSSB amongst the associated SS blocks;
   2>set the PREAMBLE_INDEX to a ra-Preamblelndex corresponding to the selected SS block.
1>else if the contention free PRACH resources associated with CSI-RSs have been explicitly provided by RRC and at least one CSI-RS with CSI-RSRP above csirs-dedicatedRACH-Threshold amongst the associated CSI-RSs is available:
   2>select a CSI-RS with CSI-RSRP above csirs-dedicatedRACH-Threshold amongst the associated CSI-RSs;
   2>set the PREAMBLE_INDEX to a ra-Preamblelndex corresponding to the selected CSI-RS.
1>else:
   2>select a SS block with SS-RSRP above rsrp-ThresholdSSB;
   2>if Msg3 has not yet been transmitted:
      3>if Random Access Preambles group B exists; and
      3>if the potential Msg3 size (UL data available for transmission plus MAC header and, where required, MAC CEs) is greater than ra-Msg3SizeGroupA and the pathloss is less than PCMAX (of the Serving Cell performing the Random Access Procedure)−ra-PreambleInitialReceivedTargetPower:
         4>select the Random Access Preambles group B.
      3>else:
         4>select the Random Access Preambles group A.
   2>else (i.e. Msg3 is being retransmitted):
      3>select the same group of Random Access Preambles as was used for the preamble transmission attempt corresponding to the first transmission of Msg3.
   2>if the association between Random Access Preambles and SS blocks is configured:
      3>select a ra-Preamblelndex randomly with equal probability from the random access preambles associated with the selected SS block and the selected group.
   2>else:
      3>select a ra-PreambleIndex randomly with equal probability from the random access preambles within the selected group.
   2>set the PREAMBLE_INDEX to the selected ra-PreambleIndex.
1>if an SS block is selected above and an association between PRACH occasions and SS blocks is configured:
   2>determine the next available PRACH occasion from the PRACH occasions corresponding to the selected SS block.

1>else if a CSI-RS is selected above and an association between PRACH occasions and CSI-RSs is configured:

2>determine the next available PRACH occasion from the PRACH occasions corresponding to the selected CSI-RS.

1>else:

2>determine the next available PRACH occasion.
1>perform the Random Access Preamble transmission procedure (see subclause 5.1.3).
   5.1.3 Random Access Preamble transmission
   The MAC entity shall, for each preamble:
1>if PREAMBLE_TRANSMISSION_COUNTER is greater than one; and
1>if the notification of suspending power ramping counter has not been received from lower layers; and
1>if SS block selected is not changed (i.e. same as the previous random access preamble transmission):
   2>increment PREAMBLE_POWER_RAMPING_COUNTER by 1.
1>set PREAMBLE_RECEIVED_TARGET_POWER to ra-PreambleInitialReceivedTargetPower+DELTA_PREAMBLE+(PREAMBLE_POWER_RAMPING_COUNTER−1)*powerRampingStep;
1>except for contention free preamble for beam failure recovery request, compute the RA-RNTI associated with the PRACH in which the Random Access Preamble is transmitted;
1>instruct the physical layer to transmit the preamble using the selected PRACH, corresponding RA-RNTI (if available), PREAMBLE_INDEX and PREAMBLE_RECEIVED_TARGET_POWER.
   The RA-RNTI associated with the PRACH in which the Random Access Preamble is transmitted, is computed as:

RA-RNTI=1+s_id+14*t_id+14*X*f_id+14*X*Y*ul_carrier_id

where s_id is the index of the first OFDM symbol of the specified PRACH (0≤s_id<14), t_id is the index of the first slot of the specified PRACH in a system frame (0≤t_id<X), f_id is the index of the specified PRACH in the frequency domain (0≤f_id<Y), and ul_carrier_id is the UL carrier used for Msg1 transmission (0 for normal carrier, and 1 for SUL carrier). The values X and Y are specified in TS 38.213 [6].

### 5.1.4 Random Access Response Reception

Once the Random Access Preamble is transmitted and regardless of the possible occurrence of a measurement gap, the MAC entity shall:
1>if ‘multiple preamble transmission’ has been signalled:
   2>start the ra-ResponseWindow at the start of the first PDCCH occasion after a fixed duration of X symbols (specified in TS 38.213 [6]) from the end of the first preamble transmission;
   2>monitor the PDCCH of the SpCell for Random Access Response(s) identified by the RA-RNTI(s) while ra-ResponseWindow is running.
1>else if the contention free Random Access Preamble for beam failure recovery request was transmitted by the MAC entity:
   2>start the bfr-ResponseWindow at the start of the first PDCCH occasion after a fixed duration of X symbols (specified in TS 38.213 [6]) from the end of the preamble transmission;
   2>monitor the PDCCH of the SpCell for response to beam failure recovery request identified by the C-RNTI while bfr-ResponseWindow is running.
1>else:
   2>start the ra-ResponseWindow at the start of the first PDCCH occasion after a fixed duration of X symbols (specified in TS 38.213 [6]) from the end of the preamble transmission;
   2>monitor the PDCCH of the SpCell for Random Access Response(s) identified by the RA-RNTI while the ra-ResponseWindow is running.
1>if PDCCH transmission is addressed to the C-RNTI; and
1>if the contention free Random Access Preamble for beam failure recovery request was transmitted by the MAC entity:
   2>consider the Random Access procedure successfully completed.
1>else if a downlink assignment has been received on the PDCCH for the RA-RNTI and the received TB is successfully decoded:
   2>if the Random Access Response contains a Backoff Indicator subheader:
      3>set the PREAMBLE_BACKOFF to value of the BI field of the Backoff Indicator subheader using Table 7.2-1.
   2>else:
      3>set the PREAMBLE_BACKOFF to 0 ms.
   2>if the Random Access Response contains a Random Access Preamble identifier corresponding to the transmitted PREAMBLE_INDEX (see subclause 5.1.3):
      3>consider this Random Access Response reception successful.
   2>if the Random Access Response reception is considered successful:
      3>if the Random Access Response includes RAPID only:
         4>consider this Random Access procedure successfully completed;
         4>indicate the reception of an acknowledgement for the SI request to upper layers.
      3>else:
         4>if ‘multiple preamble transmission’ has been signalled: 5>stop transmitting remaining preambles, if any.
         4>apply the following actions for the Serving Cell where the Random Access Preamble was transmitted: 5>process the received Timing Advance Command (see subclause 5.2); 5>indicate the ra-PreambleInitialReceivedTargetPower and the amount of power ramping applied to the latest preamble transmission to lower layers (i.e. (PREAMBLE_POWER_RAMPING_COUNTER−1)*powerRampingStep); 5>process the received UL grant value and indicate it to the lower layers.
         4>if the Random Access Preamble was not selected by the MAC entity among the common PRACH preambles: 5>consider the Random Access procedure successfully completed.
         4>else: 5>set the TEMPORARY_C-RNTI to the value received in the Random Access Response; 5>if this is the first successfully received Random Access Response within this Random Access procedure: 6>if the transmission is not being made for the CCCH logical channel: 7>indicate to the Multiplexing and assembly entity to include a C-RNTI MAC CE in the subsequent uplink transmission. 6>obtain the MAC PDU to transmit from the Multiplexing and assembly entity and store it in the Msg3 buffer.
1>if ra-Response Window expires, and if the Random Access Response containing Random Access Preamble identifiers that matches the transmitted PREAMBLE_INDEX has not been received; or
1>if bfr-ResponseWindow expires and if the PDCCH addressed to the C-RNTI has not been received:
   2>consider the Random Access Response reception not successful;
   2>increment PREAMBLE_TRANSMISSION_COUNTER by 1;
   2>if PREAMBLE_TRANSMISSION_COUNTER=ra-PreambleTx-Max+1:
      3>if the Random Access Preamble is transmitted on the SpCell:
         4>indicate a Random Access problem to upper layers.
      3>else if the Random Access Preamble is transmitted on a SCell:
         4>consider the Random Access procedure unsuccessfully completed.
   2>if in this Random Access procedure, the Random Access Preamble was selected by MAC among the common PRACH preambles:
      3>select a random backoff time according to a uniform distribution between 0 and the PREAMBLE_BACKOFF;
      3>delay the subsequent Random Access Preamble transmission by the backoff time.
   2>perform the Random Access Resource selection procedure (see subclause 5.1.2).
      The MAC entity may stop ra-Response Window (and hence monitoring for Random Access Response(s)) after successful reception of a Random Access Response containing Random Access Preamble identifiers that matches the transmitted PREAMBLE_INDEX. HARQ operation is not applicable to the Random Access Response transmission.

### 5.1.5 Contention Resolution

Contention Resolution is based on either C-RNTI on PDCCH of the SpCell or UE Contention Resolution Identity on DL-SCH.
Once Msg3 is transmitted, the MAC entity shall:
1>start the ra-ContentionResolutionTimer and restart the ra-ContentionResolutionTimer at each HARQ retransmission;
1>monitor the PDCCH while the ra-ContentionResolutionTimer is running regardless of the possible occurrence of a measurement gap;
1>if notification of a reception of a PDCCH transmission is received from lower layers:
   2>if the C-RNTI MAC CE was included in Msg3:
      3>if the Random Access procedure was initiated by the MAC sublayer itself or by the RRC sublayer and the PDCCH transmission is addressed to the C-RNTI and contains an UL grant for a new transmission; or
      3>if the Random Access procedure was initiated by a PDCCH order and the PDCCH transmission is addressed to the C-RNTI:
         4>consider this Contention Resolution successful;
         4>stop ra-ContentionResolutionTimer;
         4>discard the TEMPORARY_C-RNTI;
         4>consider this Random Access procedure successfully completed.
   2>else if the CCCH SDU was included in Msg3 and the PDCCH transmission is addressed to its TEMPORARY_C-RNTI:
      3>if the MAC PDU is successfully decoded:
         4>stop ra-ContentionResolutionTimer;
         4>if the MAC PDU contains a UE Contention Resolution Identity MAC CE; and
         4>if the UE Contention Resolution Identity in the MAC CE matches the CCCH SDU transmitted in Msg3: 5>consider this Contention Resolution successful and finish the disassembly and demultiplexing of the MAC PDU; 5>set the C-RNTI to the value of the TEMPORARY_C-RNTI; 5>discard the TEMPORARY_C-RNTI; 5>consider this Random Access procedure successfully completed.
         4>else 5>discard the TEMPORARY_C-RNTI; 5>consider this Contention Resolution not successful and discard the successfully decoded MAC PDU.
1>if ra-ContentionResolutionTimer expires:
   2>discard the TEMPORARY_C-RNTI;
   2>consider the Contention Resolution not successful.
1>if the Contention Resolution is considered not successful:
   2>flush the HARQ buffer used for transmission of the MAC PDU in the Msg3 buffer;
   2>increment PREAMBLE_TRANSMISSION_COUNTER by 1;
   2>if PREAMBLE_TRANSMISSION_COUNTER=preambleTransMax+1:
      3>indicate a Random Access problem to upper layers.
   2>select a random backoff time according to a uniform distribution between 0 and the PREAMBLE_BACKOFF;
   2>delay the subsequent Random Access Preamble transmission by the backoff time;
   2>perform the Random Access Resource selection procedure (see subclause 5.1.2).

### 5.1.6 Completion of the Random Access Procedure

Upon completion of the Random Access procedure, the MAC entity shall:
1>discard explicitly signalled ra-PreambleIndex, if any;
1>flush the HARQ buffer used for transmission of the MAC PDU in the Msg3 buffer.
   [. . . ]

### 5.4.3 Multiplexing and Assembly

### 5.4.3.1 Logical Channel Prioritization

### 5.4.3.1.1 General

The Logical Channel Prioritization procedure is applied whenever a new transmission is performed.
RRC controls the scheduling of uplink data by signalling for each logical channel per MAC entity:
priority where an increasing priority value indicates a lower priority level;
prioritisedBitRate which sets the Prioritized Bit Rate (PBR);
bucketSizeDuration which sets the Bucket Size Duration (BSD).
   RRC additionally controls the LCP procedure by configuring mapping restrictions for each logical channel:
Icp-allowedSCS which sets the allowed Subcarrier Spacing(s) for transmission;
Icp-maxPUSCH-Duration which sets the maximum PUSCH duration allowed for transmission;
Icp-configuredGrantType1Allowed which sets whether a Configured Grant Type 1 can be used for transmission;
Icp-allowedServingCells which sets the allowed cell(s) for transmission.
   The MAC entity shall maintain a variable Bj for each logical channel j. Bj shall be initialized to zero when the related logical channel is established, and incremented before every instance of the LCP procedure by the product PBR×T, where PBR is Prioritized Bit Rate of logical channel j and T is the time elapsed since Bj was last updated. The exact moment(s) when the UE updates Bj between LCP procedures is up to UE implementation, as long as Bj is up to date at the time when a grant is processed by LCP. However, the value of Bj can never exceed the bucket size and if the value of Bj is larger than the bucket size of logical channel j, it shall be set to the bucket size. The bucket size of a logical channel is equal to PBR×BSD.

If the MAC entity is requested to simultaneously transmit multiple MAC PDUs, or if the MAC entity receives the multiple UL grants within one or more coinciding PDCCH occasions (i.e. on different serving cells), it is up to UE implementation in which order the grants are processed.

### 5.4.3.1.2 Selection of Logical Channels

The MAC entity shall, when a new transmission is performed:
1>select the logical channels for each UL grant that satisfy all the following conditions:
   2>the set of allowed Subcarrier Spacing index values in Icp-allowedSCS, if configured, includes the Subcarrier Spacing index associated to the UL grant; and
   2>Icp-maxPUSCH-Duration, if configured, is larger than or equal to the PUSCH transmission duration associated to the UL grant; and
   2>Icp-configuredGrantType1Allowed, if configured, is set to TRUE in case the UL grant is a Configured Grant Type 1; and
   2>Icp-allowedServingCells, if configured, includes the Cell information associated to the UL grant.
NOTE: The Subcarrier Spacing index, PUSCH transmission duration and Cell information are included in Uplink transmission information received from lower layers for the corresponding scheduled uplink transmission.

### 5.4.3.1.3 Allocation of Resources

The MAC entity shall, when a new transmission is performed:
1>allocate resources to the logical channels as follows:
   2>logical channels selected in subclause 5.4.3.1.2 for the UL grant with Bj>0 are allocated resources in a decreasing priority order. If the PBR of a logical channel is set to “infinity”, the MAC entity shall allocate resources for all the data that is available for transmission on the logical channel before meeting the PBR of the lower priority logical channel(s);
   2>decrement Bj by the total size of MAC SDUs served to logical channel j above;
NOTE: The value of Bj can be negative.
   2>if any resources remain, all the logical channels selected in subclause 5.4.3.1.2 are served in a strict decreasing priority order (regardless of the value of Bj) until either the data for that logical channel or the UL grant is exhausted, whichever comes first. Logical channels configured with equal priority should be served equally.
      The UE shall also follow the rules below during the scheduling procedures above:
the UE should not segment an RLC SDU (or partially transmitted SDU or retransmitted RLC PDU) if the whole SDU (or partially transmitted SDU or retransmitted RLC PDU) fits into the remaining resources of the associated MAC entity;
if the UE segments an RLC SDU from the logical channel, it shall maximize the size of the segment to fill the grant of the associated MAC entity as much as possible;
the UE should maximise the transmission of data;
if the MAC entity is given an UL grant size that is equal to or larger than 8 bytes while having data available for transmission, the MAC entity shall not transmit only padding BSR and/or padding.
   The MAC entity shall not generate a MAC PDU for the HARQ entity if the following conditions are satisfied:
the MAC entity is configured with skipUplinkTxDynamic and the grant indicated to the HARQ entity was addressed to a C-RNTI, or the grant indicated to the HARQ entity is a configured uplink grant; and
the MAC PDU includes zero MAC SDUs; and
the MAC PDU includes only the periodic BSR and there is no data available for any LCG, or the MAC PDU includes only the padding BSR.
   Logical channels shall be prioritised in accordance with the following order (highest priority listed first):
MAC CE for C-RNTI or data from UL-CCCH;
MAC CE for SPS confirmation;
MAC CE for BSR, with exception of BSR included for padding;
MAC CE for single entry PHR or multiple entry PHR;
data from any Logical Channel, except data from UL-CCCH;
MAC CE for BSR included for padding.

### 5.4.3.2 Multiplexing of MAC Control Elements and MAC SDUs

The MAC entity shall multiplex MAC CEs and MAC SDUs in a MAC PDU according to subclauses 5.4.3.1 and 6.1.2.

### 5.4.4 Scheduling Request

The Scheduling Request (SR) is used for requesting UL-SCH resources for new transmission.
The MAC entity may be configured with zero, one, or more SR configurations. An SR configuration consists of a set of PUCCH resources for SR across different BWPs and cells. For a logical channel, at most one PUCCH resource for SR is configured per BWP.
Each SR configuration corresponds to one or more logical channels. Each logical channel may be mapped to zero or one SR configuration, which is configured by RRC. The SR configuration of the LCH that triggered the BSR (subclause 5.4.5) (if such a configuration exists) is considered as corresponding SR configuration for the triggered SR. For BSR triggered by retxBSR-Timer expiry, the corresponding SR configuration for the triggered SR is that of the highest priority LCH (if such a configuration exists) that has data available for transmission at the time the BSR is triggered.
RRC configures the following parameters for the scheduling request procedure:
sr-ProhibitTimer (per SR configuration);
sr-TransMax (per SR configuration);
sr-ConfigIndex.
   The following UE variables are used for the scheduling request procedure:
SR_COUNTER (per SR configuration).
   If an SR is triggered and there are no other SRs pending corresponding to the same SR configuration, the MAC entity shall set the SR_COUNTER of the corresponding SR configuration to 0.
   When an SR is triggered, it shall be considered as pending until it is cancelled. All pending SR(s) shall be cancelled and each respective sr-ProhibitTimer shall be stopped when a MAC PDU is assembled and this PDU includes a BSR which contains buffer status up to (and including) the last event that triggered a BSR (see subclause 5.4.5), or when the UL grant(s) can accommodate all pending data available for transmission.
   Only PUCCH resources on a BWP which is active at the time of SR transmission occasion are considered valid.
   As long as at least one SR is pending, the MAC entity shall for each pending SR:
1>if the MAC entity has no valid PUCCH resource configured for the pending SR:
   2>initiate a Random Access procedure (see subclause 5.1) on the SpCell and cancel the pending SR.
1>else, for the SR configuration corresponding to the pending SR:
   2>when the MAC entity has an SR transmission occasion on the valid PUCCH resource for SR configured; and
   2>if sr-ProhibitTimer is not running at the time of the SR transmission occasion; and
   2>if the PUCCH resource for the SR transmission occasion does not overlap with a measurement gap; and
   2>if the PUCCH resource for the SR transmission occasion does not overlap with a UL-SCH resource:
      3>if SR_COUNTER<sr-TransMax:
         4>increment SR_COUNTER by 1;
         4>instruct the physical layer to signal the SR on one valid PUCCH resource for SR;
         4>start the sr-ProhibitTimer.
      3>else:
         4>notify RRC to release PUCCH for all serving cells;
         4>notify RRC to release SRS for all serving cells;
         4>clear any configured downlink assignments and uplink grants;
         4>initiate a Random Access procedure (see subclause 5.1) on the SpCell and cancel all pending SRs.
NOTE: The selection of which valid PUCCH resource for SR to signal SR on when the MAC entity has more than one overlapping valid PUCCH resource for the SR transmission occasion is left to UE implementation.

### 5.4.5 Buffer Status Reporting

The Buffer Status reporting (BSR) procedure is used to provide the serving gNB with information about UL data volume in the MAC entity.
RRC configures the following parameters to control the BSR:
periodicBSR-Timer;
retxBSR-Timer;
logicalChannelSR-Delay;
logicalChannelSR-DelayTimer;
logicalChannelGroup.
   Each logical channel may be allocated to an LCG using the logicalChannelGroup. The maximum number of LCGs is eight.
   The MAC entity determines the amount of UL data available for a logical channel according to the data volume calculation procedure in TSs 38.322 and 38.323 [3] [4].
   A BSR shall be triggered if any of the following events occur:
the MAC entity has new UL data available for a logical channel which belongs to an LCG; and either
   the new UL data belongs to a logical channel with higher priority than the priority of any logical channel containing available UL data which belong to any LCG; or
   none of the logical channels which belong to an LCG contains any available UL data. in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.
   For Regular BSR, the MAC entity shall:
1>if the BSR is triggered for a logical channel for which logicalChannelSR-Delay is configured by upper layers:
   2>start or restart the logicalChannelSR-DelayTimer.
1>else:
   2>if running, stop the logicalChannelSR-DelayTimer.
      For Regular and Periodic BSR, the MAC entity shall:
1>if more than one LCG has data available for transmission when the BSR is to be transmitted:
   2>report Long BSR for all LCGs which have data available for transmission.
1>else:
   2>report Short BSR.

### For Padding BSR:

1>if the number of padding bits is equal to or larger than the size of the Short BSR plus its subheader but smaller than the size of the Long BSR plus its subheader:
   2>if more than one LCG has data available for transmission when the BSR is to be transmitted:
      3>if the number of padding bits is equal to the size of the Short BSR plus its subheader:
         4>report Short Truncated BSR of the LCG with the highest priority logical channel with data available for transmission.
      3>else:
         4>report Long Truncated BSR of the LCG(s) with the logical channels having data available for transmission following a decreasing order of priority, and in case of equal priority, in increasing order of LCGID.
   2>else:
      3>report Short BSR;
1>else if the number of padding bits is equal to or larger than the size of the Long BSR plus its subheader:
   2>report Long BSR for all LCGs which have data available for transmission.
      The MAC entity shall:
1>if the Buffer Status reporting procedure determines that at least one BSR has been triggered and not cancelled:
   2>if UL-SCH resources are available for a new immediate transmission:
      3>instruct the Multiplexing and Assembly procedure to generate the BSR MAC CE(s);
      3>start or restart periodicBSR-Timer except when all the generated BSRs are long or short Truncated BSRs;
      3>start or restart retxBSR-Timer.
   2>else if a Regular BSR has been triggered and logicalChannelSR-DelayTimer is not running:
      3>if an uplink grant is not a configured grant; or
      3>if the Regular BSR was not triggered for a logical channel for which logical channel SR masking (logicalChannelSR-Mask) is setup by upper layers:
         4>trigger a Scheduling Request.
            A MAC PDU shall contain at most one BSR MAC CE, even when multiple events have triggered a BSR by the time. The Regular BSR and the Periodic BSR shall have precedence over the padding BSR.
            The MAC entity shall restart retxBSR-Timer upon reception of a grant for transmission of new data on any UL-SCH.
            All triggered BSRs may be cancelled when the UL grant(s) can accommodate all pending data available for transmission but is not sufficient to additionally accommodate the BSR MAC control element plus its subheader. All triggered BSRs shall be cancelled when a BSR is included in a MAC PDU for transmission.
            The MAC entity shall transmit at most one BSR in one MAC PDU. Padding BSR shall not be included when the MAC PDU contains a Regular or Periodic BSR.

3GPP 38.331 describes the system information request procedure as follows:

### 5.2.2 System Information Acquisition

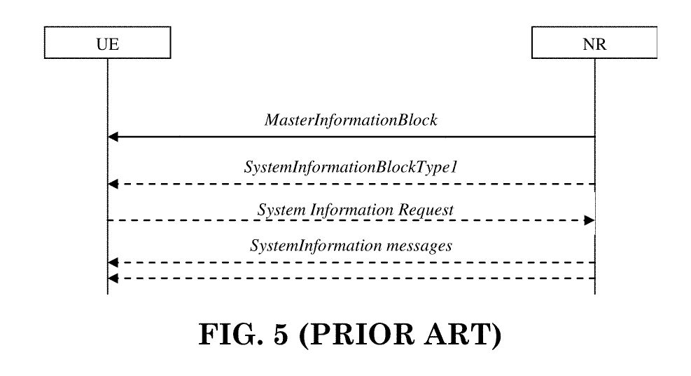

### 5.2.2.1 General UE Requirements

[FIG. 5.2.2.1-1 of 3GPP TS 38.331 V15.0.0, entitled “System information acquisition”, is reproduced as FIG. 5]
The UE applies the SI acquisition procedure to acquire the AS- and NAS information. The procedure applies to UEs in RRC_IDLE, in RRC_INACTIVE and in RRC_CONNECTED.
The UE in RRC IDLE and RRC INACTIVE shall ensure having a valid version of (at least) the MasterInformationBlock, SystemInformationBlockType1 as well as SystemInformationBlockTypeX through SystemInformationBlockTypeY (depending on support of the concerned RATs for UE controlled mobility).
The UE in RRC_CONNECTED shall ensure having a valid version of (at least) the MasterInformationBlock, SystemInformationBlockType1 as well as SystemInformationBlockTypeX (depending on support of mobility towards the concerned RATs). The UE shall store relevant SI acquired from the currently camped/serving cell. A version of the SI that the UE acquires and stores remains valid only for a certain time. The UE may use such a stored version of the SI e.g. after cell re-selection, upon return from out of coverage or after SI change indication.
Editor's Note: [FFS if the UE is required to store SI other than for the currently camped/serving cell]. FFS_Standalone
Editor's Note: [FFS if different versions of SIBs are provided]. FFS_Standalone
Editor's Note: [FFS UE may or shall store several versions of SI]. FFS_Standalone
Editor's Note: To be updated when above FFS is resolved. Another sub-clause under 5.2.2.2 can be considered depending on the resolution of above FFSs. FFS_Standalone
   5.2.2.2 SI validity and need to (re)-acquire SI
   The UE shall apply the SI acquisition procedure as defined in clause 5.2.2.3 upon cell selection (e.g. upon power on), cell-reselection, return from out of coverage, after handover completion, after entering RAN from another RAT; whenever the UE does not have a valid version in the stored SI.
Editor's Note: [FFS_Standalone if upon receiving HO command the SI acquisition depend on stored SI]
   When the UE acquires a MasterInformationBlock or a SystemInformationBlockType1 or a SI message in a currently camped/serving cell as described in clause 5.2.2.3, the UE shall store the acquired SI.

### 5.2.2.2.1 SI Validity

The UE shall:
1>delete any stored version of SI after [FFS] hours from the moment it was successfully confirmed as valid;
1>if the UE does not have in the stored SI a valid version for the required SI corresponding to the systemInfoAreaIdentifier and systemInfoValueTag/systemInfoConfigurationIndex of that SI in the currently camped/serving cell:
   2>(re)acquire the SI as specified in clause 5.2.2.3.
NOTE: At the SI acquisition procedure, the UE may assume the acquired SI in the currently camped/serving cell to be valid in other cells than the currently camped/serving cell based on systemInfoAreaIdentifier and systemInfoValueTag/systeminfoConfigurationIndex.
Editor's Note: [FFS_Standalone terminology to be used is systemInfoValueTag or systemInfoConfigurationIndex]
Editor's Note: [FFS_Standalone terminology to be used for area ID is systemInfoAreaIdentifier]
Editor's Note: [FFS_Standalone whether the area ID and valuetag is separately signalled or as a single identifier]
Editor's Note: [FFS_Standalone whether the area ID is associated to each SIB/SI message or associated to a group of SIBs/SI messages or all SIBs/SI messages]

### 5.2.2.2.2 SI Change Indication and PWS Notification

A modification period is used, i.e. updated SI is provided in the modification period following the one where SI change indication is transmitted. RAN transmits SI change indication and PWS notification through paging. Repetitions of SI change indication may occur within preceding modification period.
Editor's Note: The above descriptive text can remain in this sub-clause or moved under

### 5.2.1. FFS_Standalone

If the UE is in RRC_CONNECTED or is configured to use a DRX cycle smaller than the modification period in RRC_IDLE or in RRC_INACTIVE and receives a Paging message:
1>if the received Paging message includes the etws/cmasNotification;
   2>the UE shall immediately re-acquire the SIB1 and apply the SI acquisition procedure as defined in sub-clause [X.X.X.X FFS_Ref].

1 1>else, if the received Paging message includes the systemInfoModification;
2>the UE shall apply the SI acquisition procedure as defined in sub-clause [X.X.X.X FFS_Ref] from the start of the next modification period.
NOTE: For PWS notification the SIB1 is re-acquired to know the scheduling information for the PWS messages.
Editor's Note: [FFS_Standalone if upon receiving a SI change indication the SI acquisition depend on stored SI]
Editor's Note: [FFS_Standalone if value tags and area identifier included in paging message to reacquire SIB1]
Editor's Note: [FFS_Standalone the update mechanism for access control notifications and other non-access control configuration updates]

### 5.2.2.3 Acquisition of System Information

### 5.2.2.3.1 Acquisition of MIB and SIB1

The UE shall:
1>acquire the MIB as defined in [X];
1>if the UE is unable to acquire the MIB;
   2>follow the actions as defined in clause 5.2.2.5;
1>else:
   2>perform the actions defined in section 5.2.2.4.1;
1>acquire the SystemInformationBlockType1 as defined in [X];
1>if the UE is unable to acquire the SystemInformationBlockType1:
   2>follow the actions as defined in clause 5.2.2.5;
1>else perform the actions defined in section 5.2.2.4.2;
Editor's Note: Reference to RAN1 [X] specification may be used for the scheduling of MIB and SIB1.FFS_Standalone
   5.2.2.3.2 Acquisition of an SI message
   When acquiring an SI message, the UE shall:
1>determine the start of the SI-window for the concerned SI message as follows:
Editor's Note: [FFS_Standalone the details of the mapping to subframes/slots where the SI messages are scheduled]
Editor's Note: [FFS_Standalone if there are any exceptions on e.g. subframes where SI messages cannot be transmitted]
Editor's Note: [FFS_Standalone if the SI-windows of different SI messages do not overlap].
Editor's Note: [FFS_Standalone if multiple SI messages can be mapped to same SI window]
Editor's Note: [FFS_Standalone if the length of SI-window is common for all SI messages or if it is configured per SI message]
Editor's Note: [FFS_Standalone if the UE may accumulate the SI-Message transmissions across several SI-Windows within the Modification Period]
1>if SI message acquisition not triggered due to UE request:
   2>receive DL-SCH using the SI-RNTI from the start of the SI-window and continue until the end of the SI-window whose absolute length in time is given by si-WindowLength, or until the SI message was received;
   2>if the SI message was not received by the end of the SI-window, repeat reception at the next SI-window occasion for the concerned SI message.
1>if SI message acquisition triggered due to UE request:
   2>[FFS_Standalone receive DL-SCH using the SI-RNTI from the start of the SI-window and continue until the end of the SI-window whose absolute length in time is given by si-WindowLength, or until the SI message was received];
   2>[FFS_Standalone if the SI message was not received by the end of the SI-window, repeat reception at the next SI-window occasion for the concerned SI message].
Editor's Note: [FFS_Standalone on the details of from which SI-window the UE shall receive the DL-SCH upon triggering the SI request.
Editor's Note: [FFS_Standalone on the details of how many SI-windows the UE should monitor for SI message reception if transmission triggered by UE request]
Editor's Note: [FFS_Standalone if UE need to monitor all the TTIs in SI window for receiving SI message]
1>store the acquired SI message as specified in clause 5.2.2.2.
Editor's Note: FFS_Standalone The procedural text for SI message acquisition triggered by UE request will be updated upon finalizing the details.

### 5.2.2.3.3 Request for on Demand System Information

When acquiring an SI message, which according to the SystemInformationBlockType1 is indicated to be provided upon UE request, the UE shall:
1>if in RRC_IDLE or in RRC_INACTIVE:
   2>if the [FFS_Standalone] field is received in SIB1:
      3>the UE shall trigger the lower layer to initiate the preamble transmission procedure in accordance with TS 38.321 [3] using the [indicated PRACH preamble] and [indicated PRACH resource];

3 3>if acknowledgement for SI request is received from lower layer;
4>acquire the requested SI message(s) as defined in sub-clause 5.2.2.3.2.
   Editor's Note: To be updated with details of the Msg1 request procedure.FFS_Standalone
2>else
   3>the UE shall trigger the lower layer to initiate the random access procedure in accordance with TS 38.321 [3];
   3>if acknowledgement for SI request is received;
      4>acquire the requested SI message(s) as defined in sub-clause 5.2.2.3.2.
         Editor's Note: To be updated with details of the Msg3 request procedure. FFS_Standalone
1>else (in RRC_CONNECTED):
   2>[details FFS_Standalone]
      Editor's Note: To be updated with details of the on-demand request procedure in RRC_CONNECTED. FFS_Standalone

Editor's Note: [FFS_Standalone if there is a need for a separate sub-clause to describe case where on demand SI is not successfully received by the UE and where it should initiate a new request]

5.2.2.4 Actions upon Receipt of SI Message
5.2.2.4.1 Actions upon Reception of the MasterInformationBlock
Upon receiving the MasterInformationBlock the UE shall:
1>store the acquired MIB;
1>if the UE is in RRC IDLE or if the UE is in RRC_INACTIVE or if the UE is in RRC_CONNECTED while T311 is running: [FFS]
   2>if the cellBarred in the acquired MIB is set to barred;
      3>consider the cell as barred in accordance with TS 38.304 [FFS].
   2>else,
      3>apply the received parameter(s) [FFS] to acquire SIB1.
         Editor's Note: To be updated when content of the MasterInformationBlock has been agreed.FFS.
         5.2.2.4.2 Actions upon reception of the SysteminformationBlockType1
         Upon receiving the SystemInformationBlockType1 the UE shall:
1>store the acquired SIB1;
1>if the UE has a stored valid version of the required SIB(s) associated with the systemInfoAreaIdentifier and systemInfoValueTag/systemInfoConfigurationIndex in the acquired SIB1:
   2>use that stored version of the SIB.
1>else if the SIB1 message indicates that the SI message(s) is only provided on request:
   2>trigger a request to acquire the SI message(s) (if needed) as defined in sub-clause 5.2.2.3.
1>else:
   2>acquire the SI message(s) (if needed) as defined in sub-clause 5.2.2.3.2, which are provided according to the schedulingInfoList in the SystemInformationBlockType1.
Editor's Note: [FFS_Standalone Whether there is an additional indication that an on-demand SI is actually being broadcast at this instant in time]
Editor's Note: To be updated when content of the SystemInformationBlockType1 has been agreed. FFS_Standalone.
Editor's Note: To be updated how to capture the UE behaviour when some required SIBs are from broadcast and other required SIBs through SI request.
   5.2.2.4.3 Actions upon reception of SysterninformationBlockTypeX
Editor's Note: To be extended with further sub-clauses as more SIBs are defined. FFS_Standalone

### 5.2.2.5 Essential System Information Missing

The UE shall:
1>if in RRC_IDLE or in RRC_INACTIVE:
   2>if the UE is unable to acquire the MIB; or
   2>if the UE is unable to acquire the SIB1 and UE does not have a stored valid version of SIB1;or
   2>[FFS_Standalone if the UE is unable to acquire the [FFS essential SystemInformationBlockTypeX] and UE does not have a stored valid version of SystemInformationBlockTypeX];
      3>consider the cell as barred in accordance with TS 38.304 [X]; and
      3>perform barring as if intraFreqReselection is set to allowed;
Editor's Note: [FFS_Standalone on details of RRC connection re-establishment procedure and corresponding reading of SI in RRC_CONNECTED].
Editor's Note: [FFS_Standalone whether all the information needed to access the cell is included in SIB1 or if both SIB1 and SIB2 are essential in NR].

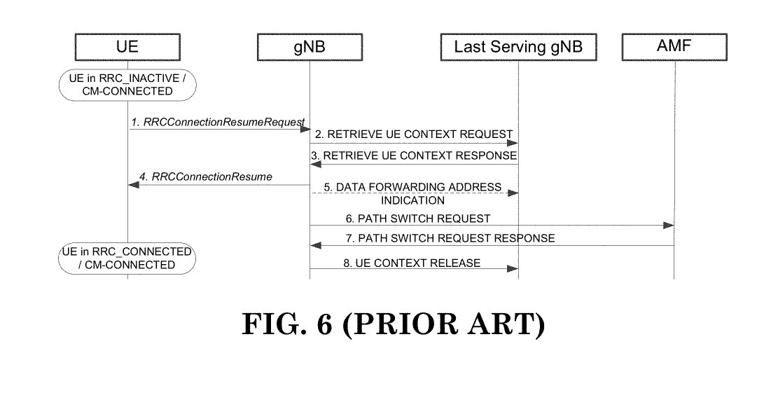

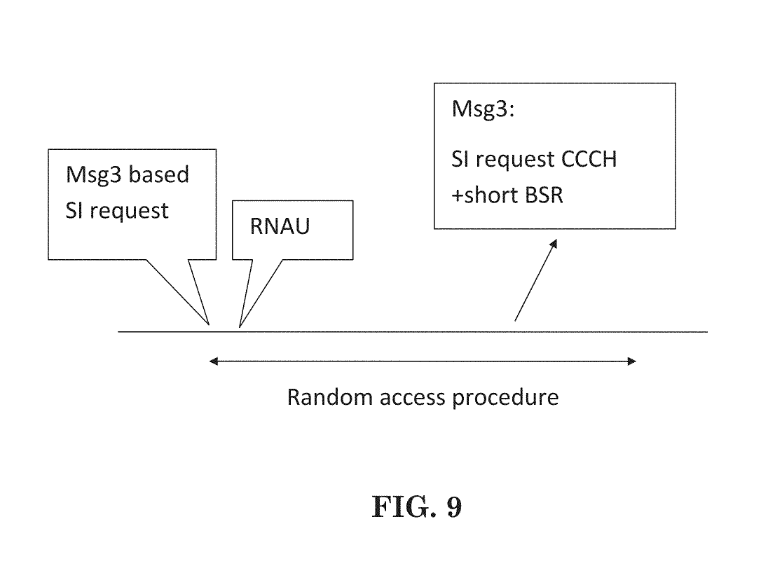

In NR, many new mechanisms are introduced for benefit this new system. For example, RRC INACTIVE state is introduced for UE to reduce access delay by storing AS context. The UE in RRC INACTIVE performs RRC connection resume procedure for recovering the connection. The RRC connection resume procedure is shown in FIG. 6, which is a reproduction of FIG. 9.2.2.4.1-1 of 3GPP TS 38.300 V15.0.0. The desciiption of each step of FIG. 6 could be found in Section 9.2.2.4.1 of 3GPP TS 38.300 V15.0.0.

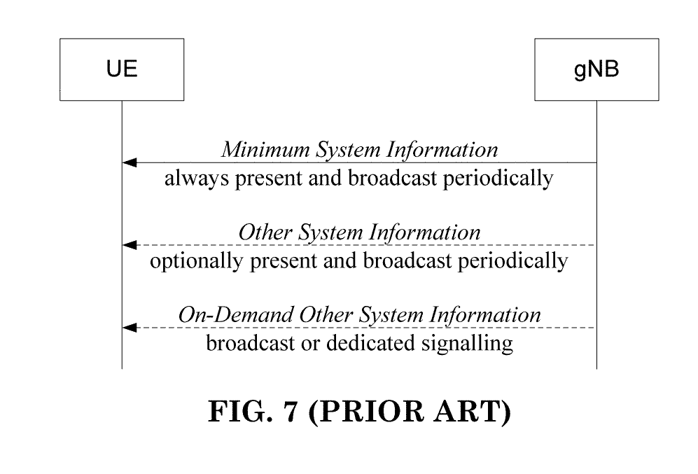

For instance, on-demand system information mechanism is introduced for reducing periodical broadcast transmissions. The power and the radio resource can be reduced. More specifically, a UE in RRC INACTIVE or in RRC IDLE can perform on-demand mechanism to request Other system information from the base station. The (Msg3 based) on-demand system information procedure is shown in FIG. 7, which is a reproduction of FIG. 7.3-1 of 3GPP 38.300 V15.0.0. The description of FIG. 7 could be found in Section 7.3-1 of 3GPP 38.300.

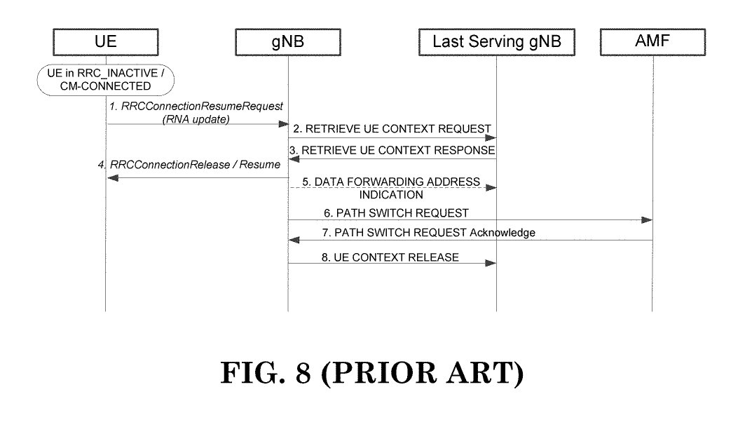

Another enhancement is introducing RAN (Radio Access Network) notification area for UE mobility. The RAN notification area is like tracking area. A UE needs to autonomously inform network about the UE location if the UE move from one RAN notification area to another RAN notification area. The RAN notification area update procedure is shown in FIG. 8, which is a reproduction of FIG. 9.2.2.5-1 of 3GPP TS 38.300 V15.0.0. The description of each step of FIG. 8 could be found Section 9.2.2.5 of 3GPP TS 38.300 V15.0.0. The RAN notification area is designed for ensuring network can forward UEs' AS (Access Stratum) context from one base station to another base station. The RAN notification area is smaller than tracking area. Based on these new mechanisms, UE needs to perform many different transmissions through CCCH (Common Control Channel) in RRC IDLE state or in RRC INACTIVE state.

In some conditions, a UE needs to trigger and to perform multiple RRC procedures. One possible condition is shown in FIG. 9. In the example shown in FIG. 9, after a UE in RRC INACTIVE moves to a new cell, the UE determines to update RAN notification area and system information. The UE could determine the RAN notification area update based on change of RAN notification area ID (in system information) or whether the new cell belongs to a configured cell(s) list. The UE could determine updating or reacquisition the system information based on system information Area ID and/or value tag(s) in system information (e.g. MIB, SIB1, RMSI, etc.). In this embodiment, the UE decides to update system information firstly and to do RNAU (RAN Notification Area Update) later.

Based on NR RRC and NR MAC (Medium Access Control) specification, if the UE needs to perform Msg3 based system information request procedure for obtaining other SI, the RRC layer delivers a RRC message for system information request (through CCCH) to MAC layer and MAC layer triggers a regular BSR and indirectly trigger a random access procedure for transmitting the RRC message for system information request (through CCCH). On the other hand, after the RRC layer delivers the RRC message for system information request (through CCCH) to MAC layer, the RRC layer could further deliver a RRC message for RNAU to the MAC layer, since there is no limitation for prohibiting UE to trigger and to run different RRC procedures in parallel. In this case, if the uplink grant in RAR is not large enough, the Msg3 could include the RRC message for system information request, short BSR MAC CE and corresponding MAC subheader(s) (and not include the RRC message for RNAU in the Msg3). And the regular BSR is cancelled.

As a result, since no UE ID is included in the RRC message for system information request, the base station cannot schedule another uplink grant for responding the short BSR. And the UE does not perform another random access procedure for transmitting the RRC message for RNAU (RAN-based Notification Area Update) due to the regular BSR cancellation. The UE cannot recover transmission for the RRC message for RNAU and the RNAU fails in this case (shown in FIG. 9). Similar condition could occur even if the RNAU procedure is replaced with a RRC connection request procedure, a RRC connection resume procedure, a tracking area update procedure, another (Msg3 based) system information request procedure, or any other RRC procedure needing a transmission of a RRC message through CCCH. The RRC connection resume procedure and the RRC connection establishment procedure could be triggered by UE itself or triggered by paging from the network. In addition, the RNAU procedure could be replaced to small data transmission procedure. In future, RAN2 could conclude the design of how UE perform small data transmission without RRC state change. The UE can perform the small data transmission in RRC INACTIVE or in RRC IDLE. The small data transmission procedure could be using RRC message to carry user data (user plane data). Alternatively, the UE could send MAC CE for BSR and data directly in RRC IDLE or in RRC INACTIVE (through Msg3 in contention based random access procedure).

On the other hand, even if the UE ID is included in system information request, the network could not be able to schedule the UE. For example, if the RNAU procedure has not been done in the new cell, the new base station cannot recognize the UE based on the UE ID. On the other hand, network cannot schedule uplink grant to the UE through C-RNTI, since the UE does not monitoring C-RNTI when the UE is in RRC INACTIVE or in RRC IDLE. Hence, the short BSR is useless for SI request procedure.

For preventing the CCCH blocking issue, following solutions are proposed. In one embodiment, the solutions are applied for UEs in RRC INACTIVE and/or UEs in RRC IDLE.

Solution 1-A UE is Allowed to Trigger and to Perform One UE Triggered RRC Procedure at a Time

In this solution, a UE is limited to trigger and to perform a RRC procedure at a time. In one embodiment, the RRC procedure could be triggered by the UE. The RRC procedure could be performed when UE is in RRC INACTIVE or in RRC IDLE. After the RRC procedure is finished, the UE can trigger or can perform another RRC procedure. The RRC procedure could be considered as finish if the RRC procedure receives corresponding response. The RRC procedure could be considered as finish if the RRC procedure does not need a response and the UE finished the transmission of a RRC message of the RRC procedure.

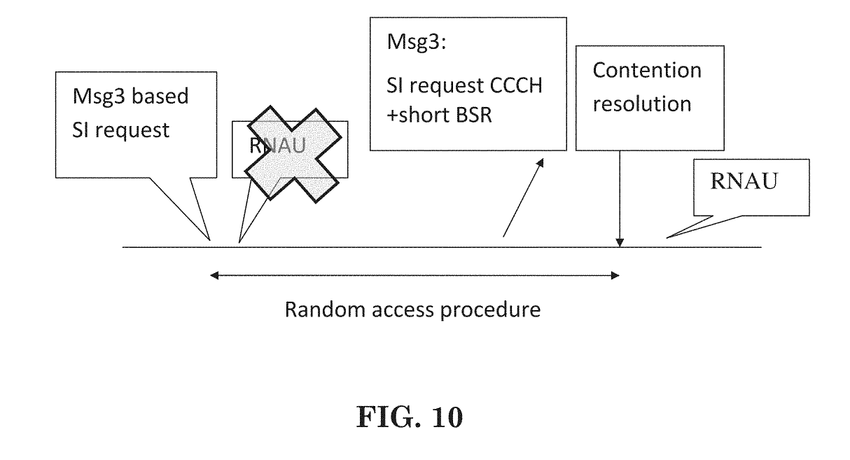

An example of applying Solution 1 is shown in FIG. 10. In FIG. 10, the UE should delay triggering of RNAU procedure if the UE decides to perform on-demand SI request at first. In one embodiment, the SI request procedure could be considered as finish if the RRC message for SI request is transmitted (e.g. receiving corresponding acknowledge or corresponding contention is resolute). The SI request procedure could be considered as finish if higher layer receives lower layer indicate transmission is finished (e.g. contention resolution).

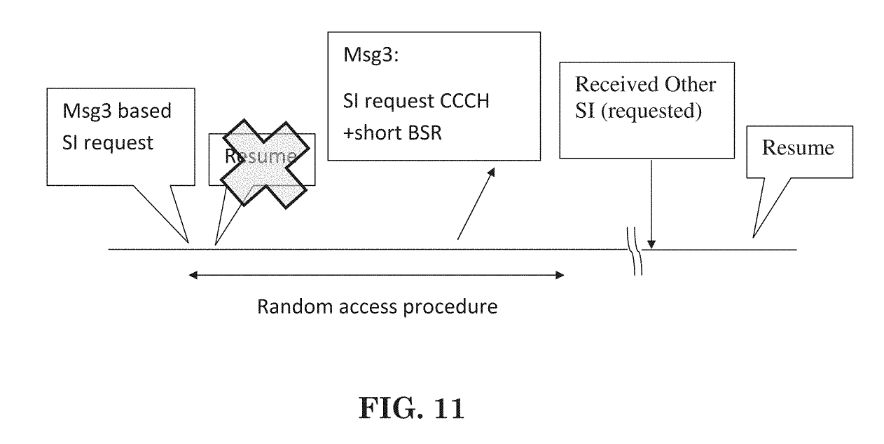

Another example of applying Solution 1 is shown in FIG. 11. In FIG. 11, the UE should delay triggering of RRC connection resume procedure if the UE decides to perform on-demand SI request at first. In one embodiment, the SI request procedure could be considered as finish if the UE receives Other SI requested by the RRC message for SI request.

In another embbodiment, the on-demand SI request procedure could not be triggered when the UE triggers or is going to trigger the RRC connection establishment procedure or RRC connection resume procedure. The on-demand SI request procedure will be delayed. In one embodiment, the on-demand SI request procedure could be performed when the UE back to RRC IDLE or RRC INACTIVE. The on-demand SI request procedure could be performed at RRC CONNECTED if SI requested by on-demand will be used in RRC CONNECTED state. In addition, if the on-demand SI request procedure is ongoing, the RRC connection establishment procedure or the RRC resume procedure could not be triggered. And the ongoing on-demand SI request procedure could not be dropped due to the RRC connection establishment procedure or the RRC resume procedure.

In general, a drawback of this solution could be that the UE cannot perform multiple RRC procedures even if the RAR uplink grant indicates large enough Msg3 size for multiple RRC messages (RRC messages through CCCH).

Solution 2-Reset MAC before Delivering the CCCH Message of the Second RRC Procedure

In this solution, a UE needs to do MAC reset before performing next RRC procedure. The next RRC procedure could be a RRC connection establishment procedure, a RRC connection resume procedure, a RNAU procedure, a tracking area update procedure, or a (Msg3 based) system information request procedure. In general, a drawback of this solution could be that the previous RRC procedure could be accidentally terminated.

Solution 3-Change Triggering Condition of a Random Access Procedure for RRC Procedure (or for CCCH Transmission)

In LTE, if a UE needs to transmit a CCCH SDU (RRC message of a RRC procedure), the CCCH SDU could trigger a random access procedure based on MAC procedure. More specifically, the UE could trigger a regular BSR for buffer changing from empty to non-empty. And the UE could trigger a random access procedure for the regular BSR, because the UE has no SR configuration in RRC INACTIVE or in RRC IDLE.

To solve the issue, the RRC layer will directly trigger a random access procedure for a RRC procedure which has to transmit at least a RRC message (e.g. a CCCH SDU) regardless of buffer status and/or regular BSR. In LTE, the RRC layer could trigger a random access procedure only in PSCell addition case. The reason is that the PSCell addition has no corresponding message for transmission which can trigger random access procedure.

Solution 4: MAC Indicates Upper Layer (i.e. RRC Layer) when Contention is Resolute, and RRC Creates or Delivers Next CCCH SDU for Lower Layer based on the Indication

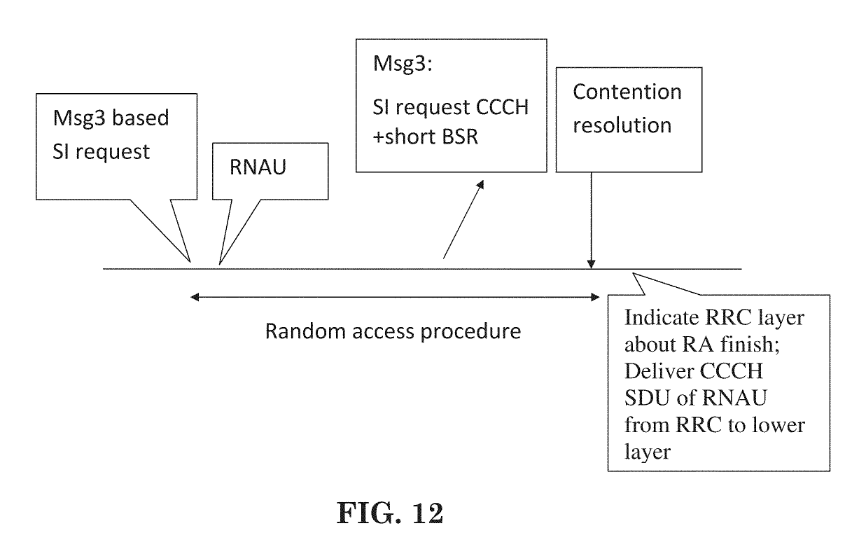

In this solution, a UE could deliver another RRC message of next RRC procedure to MAC layer for transmission after the UE finishes a RRC message transmission of previous RRC procedure. For achieving this concept, the UE could need to indicate upper layer about (successful) complete of a random access procedure and/or whether the RRC message transmission of previous RRC procedure is finished. A possible example is shown in FIG. 12. In this example, the UE can trigger the RNAU procedure but holding the CCCH SDU. And the UE can deliver the CCCH SDU to lower layer if the previous transmission of CCCH SDU is finished and/or the random access procedure success.

In general, a drawback of this solution could be that the UE cannot perform multiple RRC procedures at the same time. The RRC procedures could be triggered by UE.

Solution 5: UE Autonomously Triggers Another Regular BSR when a CCCH Data is Pending without any Triggered Regular BSR

In this case, the UE should trigger a regular BSR if there is a CCCH SDU pending in the UE. In one embodiment, the UE should trigger a regular BSR if the UE has data available for transmission and the UE is not in RRC CONNECTED. For above conditions, the UE could already report buffer status of those data available for transmission. The regular BSR is not triggered by a retransmission BSR timer.

Solution 6: UE Creates and/or Delivers CCCH Message(s) Based on TB Size Indicated by RAR Grant

A UE could create a first CCCH message for a first (triggered) RRC procedure (e.g. system information request). And the UE could trigger a random access procedure for the first CCCH message. After receiving a RAR, the UE could determine whether to create a second CCCH message for a second (triggered) RRC procedure (e.g. RNAU, RRC connection establishment, RRC connection resume, etc.) based on TB size indicated by an uplink grant in the RAR. In addition, if the TB size is large enough, the UE could consider next CCCH SDU for a third triggered RRC procedure.

Solution 7: LIE keeps Monitoring the C-RNTI for a Period (in RRC IDLE State or in RRC INACTIVE State)

In this solution, the UE in RRC IDLE or in RRC INACTIVE could need to monitor C-RNTI for a period after the contention of the random access procedure is resolute. In one embodiment, the UE could need to monitor C-RNTI if the Msg3 includes a BSR MAC CE. The Msg3 could also include a CCCH SDU. The Msg3 could also include data from DCCH or data from DRB. In one embodiment, the period could be controlled by a timer. The period could be a period before the UE re-selects to another cell. The period could also be a DRX cycle. In one embodiment, the periodic could be controlled by a counter. The base station could need to align the understanding about how long the UE will keep the C-RNTI.

Solution 8: LIE cannot include BSR MAC CE (MAC CE for BSR) into Msg3 Based on Limitation(s)

Since the regular BSR will be cancelled if the BSR MAC CE is included, it can be prevented by prohibiting the BSR MAC CE being included into the Msg3. The Msg3 could be a contention transmission in a random access procedure. The limitation could be that the UE cannot include CCCH SDU and BSR MAC CE (i.e. MAC CE for BSR) into same Msg3 (or same TB). In one embodiment, the UE could include MAC CE for BSR included for padding for this case. Alternatively, the UE could not include MAC CE for BSR included for padding. In one embodiment, the UE could not include both the CCCH SDU and the BSR MAC CE if the UE has another CCCH SDU that cannot be included into same Msg3. Alternatively, the UE could not include both the CCCH SDU and the BSR MAC CE even if the UE does not have another CCCH SDU.

In one embodiment, the regular BSR will not be cancelled when the UE multiplexes or creates the transport block. The regular BSR will be cancelled when UE resolute the contention if the UE has no more data available for transmission.

Solution 9:Always Prioritize including other RRC Message (belonging to CCCH) (e.g. RRC connection request, RRC resume request) over RRC message for system information request

In this solution, if the UE has multiple CCCH SDUs for different RRC messages, the UE could need to handle delivering order of those RRC messages. In one embodiment, the RRC layer always delivers the other RRC messages earlier than the RRC message for system information request. Alternatively, the UE could prioritize the other RRC messages when performing multiplexing of a transport block. In other words, the UE could firstly include the other RRC message and then the system information request.

In one embodiment, the other RRC messages and the RRC message for system information request could belong to same logical channel. The other RRC messages could belong to CCCH (e.g. SRB0). In one embodiment, the RRC message for system information request could have no transaction identifier. By this way, the rule of processing sequentially will not be broken. In one embodiment, the other RRC messages refer to RRCSetupRequest, RRCResumeRequest, and RRCReestablishmentRequest.

Solution 10-A UE is not allowed to Trigger RRC Connection Establishment Related Procedure (i.e. RRC connection Setup or RRC Connection Resume) and On-Demand SI Request Procedure at Same Time

In this solution, a UE could be limited to trigger RRC connection establishment related procedure and/or to trigger on-demand SI request procedure (e.g. Msg3 based on-demand SI, Msg1 based on-demand SI) with limitation(s) (e.g. depending on ongoing procedure and/or depending on procedure to be triggered). In one embodiment, a UE could not trigger a RRC connection establishment related procedure if a UE decides to trigger an on-demand SI request procedure or if the UE has an ongoing on-demand SI request procedure. In another embodiment, a UE could not trigger an on-demand SI request procedure if a UE (decides to) trigger an RRC connection establishment related procedure or if the UE has an ongoing RRC connection establishment related procedure. In other words, the UE could not have an ongoing RRC connection establishment related procedure and an ongoing on-demand SI request procedure at same time. The above embodiments could be combined to form another embodiment.

In one embodiment, a UE could not drop ongoing on-demand SI request procedure if the UE detects a condition for triggering RRC connection establishment related procedure (e.g. RRC connection resume, RRC connection establishment). A UE could also not drop ongoing RRC connection establishment related procedure if the UE detects a condition for triggering an on-demand SI request procedure. In addition, if triggering of a second RRC procedure is pending due to an ongoing RRC procedure (e.g. a first RRC procedure), the UE could trigger the second RRC procedure after the ongoing RRC procedure is finished.

In one embodiment, the SI request procedure could be considered as finish if the UE receives Other SI requested by the RRC message for SI request. In particular, the SI request procedure could also be considered as finish if the RRC message for SI request is transmitted (e.g. receiving corresponding acknowledge or corresponding contention is resolute). Furthermore, the SI request procedure could be considered as finish if higher layer receives lower layer indicate transmission is finished (e.g. contention resolution).

In one embodiment, other RRC procedures different from RRC connection resume procedure, RRC connection request procedure, or Msg3 based system information request procedure could be triggered and run in parallel with RRC connection resume procedure, RRC connection request procedure, or Msg3 based system information request procedure.

Possible conditions of triggering RRC connection establishment related procedure are listed in below:
1. A UE is paged by network (e.g. base station or core network);
2. Tracking area update (TrackingAreaCode in system information is changed when UE camps on a new cell);
3. RAN notification area update (e.g. a UE camps on a new cell which belonging to different RAN notification area from RAN notification area of previously camped cell, periodic RAN area update timer expiry,); and/or
4. NAS indicates connection establishment to RRC.

Possible conditions of triggering on-demand SI request procedure include:

1. System Information Area ID change (in system information)
2. Has no valid system information (e.g. mobility related SI)
3. A UE initiates a service which needs system information (e.g. V2X, MBMS)

Solution 10 could be applied on some SI request triggering conditions and/or some connection establishment triggering conditions, instead of all conditions. For example, only Condition 2 and Condition 3 of connection establishment triggering will prohibit or be prohibited based on on-demand SI request procedure. Nevertheless, no combination of conditions is precluded.

Below are possible text proposals for Solution 10 based on 3GPP R2-1809109 and R2-1808000. The words with underline is the text proposals added for Solution 10.

5.2.2.4.2 Actions upon reception of the SIB1
Upon receiving the SIB1 the UE shall:
1>store the acquired SIB1;
1>if the cellAccessRelatedInfo contains an entry with the PLMN-Identity of the selected PLMN:
   2>in the remainder of the procedures use plmn-IdentityList, trackingAreaCode, and cellIdentity for the cell as received in the corresponding cellAccessRelatedInfo containing the selected PLMN;
1>forward the cellIdentity to upper layers;
1>forward the trackingAreaCode to upper layers;
1>forward the ims-EmergencySupport to upper layers, if present;
1>forward the eCallOverIMS-Support to upper layers, if present;
1>apply the configuration included in the servingCellConfigCommon;
1>if the UE has a stored valid version of a required SIB in accordance with sub-clause 5.2.2.2.1:
   2>use that stored version of the SIB;
1>if the UE has not stored the valid version of one or several required SIB(s), in accordance with sub-clause 5.2.2.2.1, and if the UE is not performing or is going to perform RRC connection establishment procedure or RRC connection resume procedure:
   2>for the SI message(s) containing the required SIB(s) according to the the si-SchedulingInfo in the SIB1:
      3>if indicated as currently not broadcast;
         4>trigger a request to acquire the SI message(s) (if needed) as defined in sub-clause 5.2.2.3.3.
      3>else;
         4>acquire the SI message(s) (if needed) as defined in sub-clause 5.2.2.3.2;
            [. . . ]

### 5.3.3.2 Initiation

The UE initiates the procedure when upper layers request establishment of an RRC connection while the UE is in RRC_IDLE and the UE is not performing or is going to perform Request for on demand system information.
Upon initiation of the procedure, the UE shall:
1>apply the default physical channel configuration as specified in x.x.x;
1>apply the default semi-persistent scheduling configuration as specified in x.x.x;
1>apply the default MAC main configuration as specified in x.x.x;
1>apply the CCCH configuration as specified in 9.1.1.2;
1>start timer T300;
1>initiate transmission of the RRCSetupRequestmessage in accordance with 5.3.3.3;

### 5.3.13.2 Initiation

The UE initiates the procedure when upper layers or AS requests resume of an RRC connection, when responding to NG-RAN paging or upon triggering RNA updates while the UE is in RRC_INACTIVE and the UE is not performing or is going to perform Request for on demand system information.
Upon initiation of the procedure, the UE shall:
Editor's Note: FES Whether SCG configuration should be released or whether that should be treated as any other configuration (i.e. with delta signalling).
1>apply L1/L2 default configurations;
1>apply the CCCH configuration as specified in 9.1.1.2;
Editor's Note: FFS Whether NR supports a timeAlignmentTimerCommon, whether is transmitted in SIB2 and UE behavior associated).
1>start timer T319;
1>stop timer T380;
1>initiate transmission of the RRCResumeRequest message in accordance with 5.3.13.3;
Editor's Note: FFS Requirements on up to date system information acquisiton before connection resumption.
Editor's Note: FFS Details regarding default L1/L2 configurations (e.g. CCCH, physical channel, MAC, scheduling, etc.) for Resume Request.

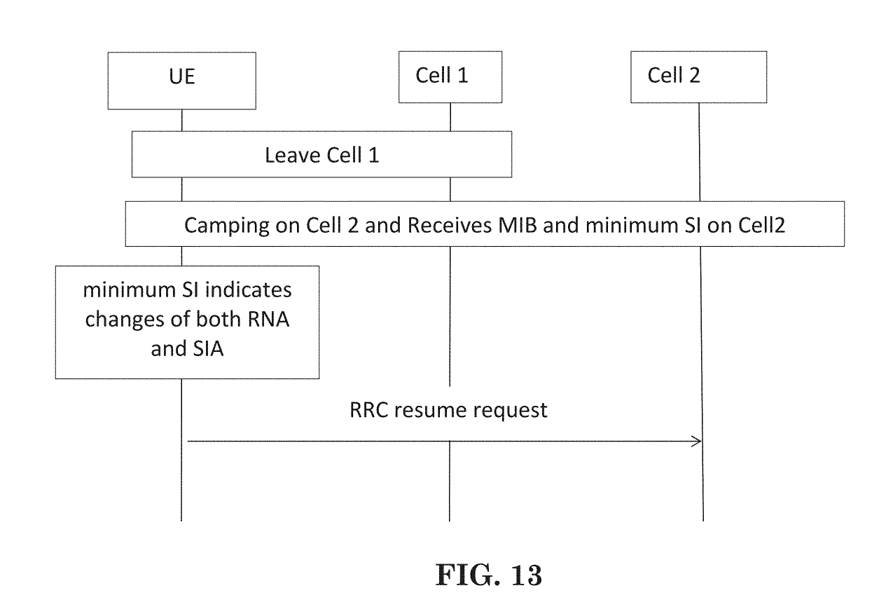

FIG. 13 shows an exemplary embodiment of Solution 10. FIG. 13 illustrates an example of how to handle collision based on Solution 10. Since the UE could detect triggering condition of connection establishment procedure and triggering condition of on-demand SI request procedure based on received SI (e.g. SIB1, MIB, RMSI), the UE could perform either one procedure and could hold another one procedure based on Solution 10. In this example, the RRC resume request procedure could be selected, and SI request could be pending (not triggered). After the RRC resume request procedure is finished, the UE could perform the pending SI request procedure.

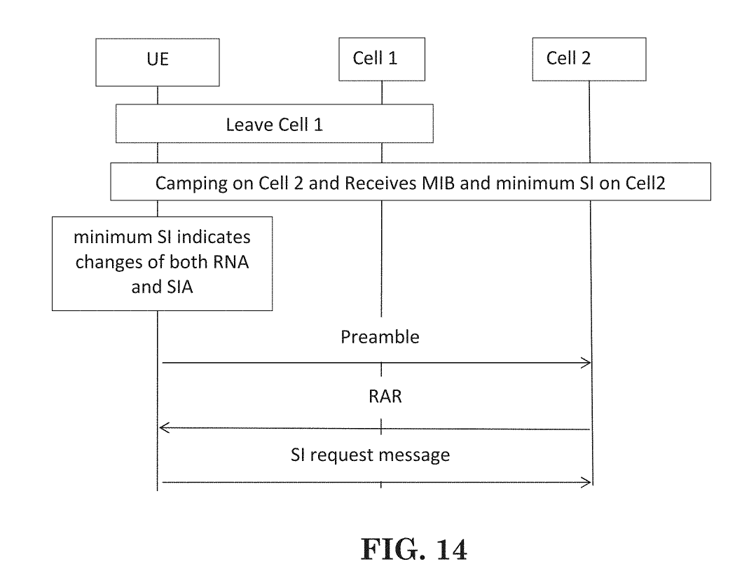

FIG. 14 shows another exemplary embodiment of Solution 10. FIG. 14 illustrates an example of how to handle collision based on Solution 10. Since the UE could detect triggering condition of connection establishment procedure and triggering condition of on-demand. SI request procedure based on received SI (e.g. SIB1, MIB, RMSI), the UE could perform either one procedure and could hold another one procedure based on Solution 10. In this example, the SI request procedure could be selected, and RRC connection establishment could be pending (not triggered). After the SI request procedure is finished, the UE could perform the pending RRC connection establishment.

For the above solutions, the first RRC procedure could be a Msg3 based system information request procedure, a RRC connection request procedure, a RRC connection resume procedure, a tracking area update procedure, a RNAU procedure, or a RRC connection establishment procedure. The second RRC procedure could be another Msg3 based system information request, a RRC connection request procedure, a RRC connection resume procedure, a tracking area update procedure, a RNAU procedure, or a RRC connection establishment procedure.

For the above solutions, the RRC procedure could be a Msg3 based system information request, a RRC connection request procedure, a RRC connection resume procedure, a tracking area update procedure, a RNAU procedure, or a RRC connection establishment procedure.

In one embodiment, the RRC procedure for system information request could be considered as finish when the RRC message for system information request is transmitted by the UE. Alternatively, the RRC procedure for system information request could be considered as finish when the RRC message for system information request is transmitted and corresponding system information(s) are received by the UE.

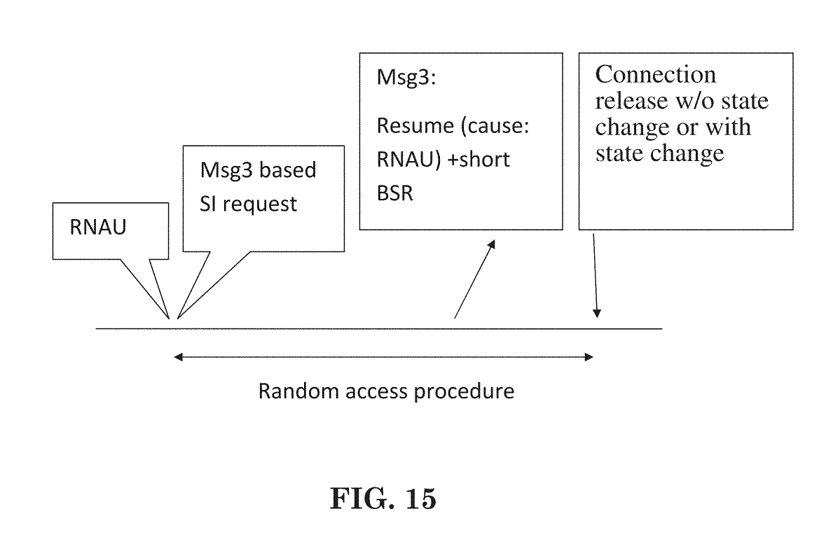

Moreover, if the first RRC procedure is not SI request procedure, the same issue could still occur. One possible example is shown in FIG. 15. In this example, the first RRC procedure could be a RNAU procedure. If network does not let the UE enter RRC CONNECTED for responding RNAU request, the RRC message for system information request (CCCH SDU) could be blocked. The network could keep the UE in RRC INACTIVE or could change the UE to RRC IDLE (due to UE context fetch failure or cell loading). The solutions discussed above could also be considered for solving this condition.

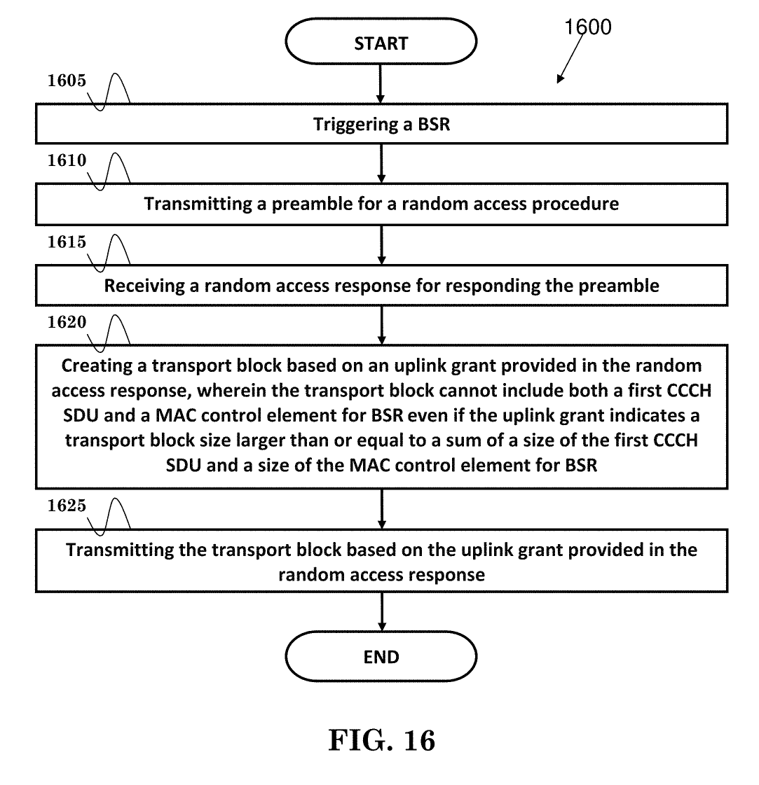

FIG. 16 is a flow chart 1600 according to one exemplary embodiment from the perspective of a network node. In step 1605, the UE triggers a BSR. In step 1610, the UE transmits a preamble for a random access procedure. In step 1615, the UE receives a random access response for responding the preamble. In step 1620, the UE creates a transport block based on an uplink grant provided in the random access response, wherein the transport block cannot include both a first CCCH (Common Control Channel) SDU (Service Data Unit) and a MAC (Medium Access Control) control element for BSR even if the uplink grant indicates a transport block size larger than or equal to a sum of a size of the first CCCH SDU and a size of the MAC control element for BSR. In step 1625, the UE transmits the transport block based on the uplink grant provided in the random access response.

In one embodiment, the. BSR is a regular BSR. The BSR could not be cancelled when creating the transport block. The BSR could not be cancelled when transmitting the transport block. The random access procedure is triggered for the BSR. The size of the MAC control element for BSR is also taken corresponding MAC subheader into account. The size of the first CCCH SDU is also taken corresponding MAC subheader into account.

In one embodiment, the transport block could not include both the first CCCH SDU and the MAC control element for BSR if the UE has a second CCCH SDU cannot be included into the transport block due to the transport block size indicated by the uplink grant is not enough. In one embodiment, the transport block size is not enough to accommodate both the first CCCH SDU and the second CCCH SDU. The MAC control element for BSR could not be a BSR included for padding. The MAC control element for BSR could be a BSR included for padding. The BSR could be triggered due to first CCCH SDU arriving while buffer is empty.

Referring back to FIGS. 3 and 4, in one exemplary embodiment of a network node, the device 300 includes a program code 312 stored in the memory 310. The CPU 308 could execute program code 312 to enable the network node (i) to trigger a BSR, (ii) to transmit a preamble for a random access procedure, (iii) to receive a random access response for responding the preamble, (iv) to create a transport block based on an uplink grant provided in the random access response, wherein the transport block cannot include both a first CCCH SDU and a MAC control element for BSR even if the uplink grant indicates a transport block size larger than or equal to a sum of a size of the first CCCH SDU and a size of the MAC control element for BSR, and (v) to transmit the transport block based on the uplink grant provided in the random access response. Furthermore, the CPU 308 can execute the program code 312 to perform all of the above-described actions and steps or others described herein.

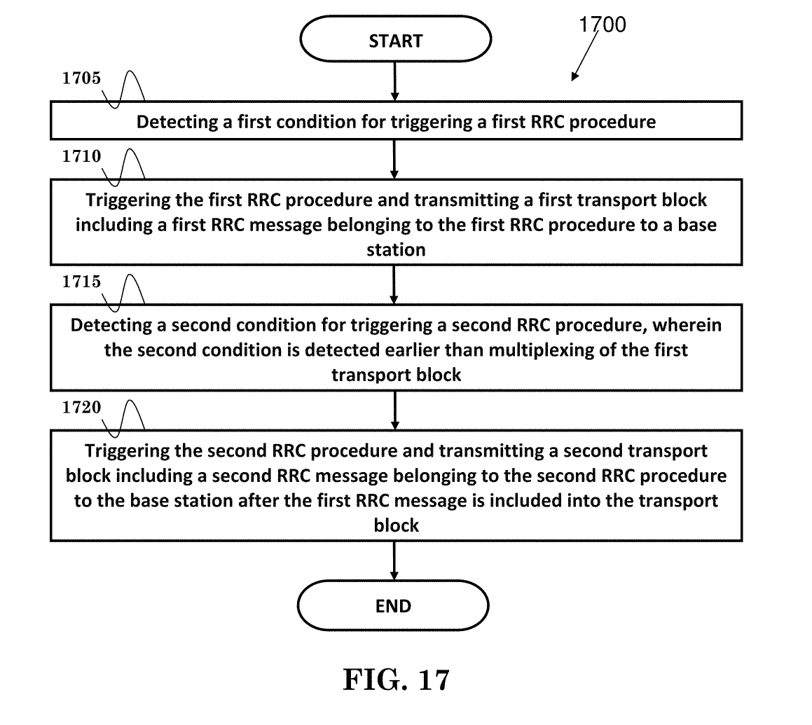

FIG. 17 is a flow chart 1700 according to one exemplary embodiment from the perspective of a UE. In step 1705, the UE detects a first condition for triggering a first RRC procedure. In step 1710, the UE triggers the first RRC procedure and transmitting a first transport block including a first RRC message belonging to the first RRC procedure to a base station. In step 1715, the UE detects a second condition for triggering a second RRC procedure, wherein the second condition is detected earlier than multiplexing of the first transport block. In step 1720, the UE triggers the second RRC procedure and transmitting a second transport block including a second. RRC message belonging to the second. RRC procedure to the base station after the first RRC message is included into the transport block.

In one embodiment, the second RRC procedure could be triggered after the first RRC procedure is finished or after the first transport block is multiplexed. In one embodiment, the second condition could be detected, and the first condition could be detected based on same message (e.g. SIB1) from the base station.

In one embodiment, the first RRC procedure could be RRC connection establishment or RRC connection resume; and the first condition could be RAN (Radio Access Network) notification area update, tracking area update, mo-data, emergency call, mo-signaling, or mt-access. The second RRC procedure is a system information request; and the second condition is a system information area change, a system information update, or an acquiring system information.

In one embodiment, the second RRC procedure could be RRC connection establishment or RRC connection resume; and the second condition could be RAN notification area update, tracking area update, mo-data, emergency call, mo-signaling, or mt-access. The first RRC procedure could be a system information request; and the first condition could be a system information area change, a system information update, or an acquiring system information.

Referring back to FIGS. 3 and 4, in one exemplary embodiment of a UE, the device 300 includes a program code 312 stored in the memory 310. The CPU 308 could execute program code 312 to enable the UE (i) to detect a first condition for triggering a first RRC procedure, (ii) to trigger the first RRC procedure and transmitting a first transport block including a first RRC message belonging to the first RRC procedure to a base station, (iii) to detect a second condition for triggering a second RRC procedure, wherein the second condition is detected earlier than multiplexing of the first transport block, and (iv) to trigger the second RRC procedure and transmitting a second transport block including a second RRC message belonging to the second RRC procedure to the base station after the first RRC message is included into the transport block. Furthermore, the CPU 308 can execute the program code 312 to perform all of the above-described actions and steps or others described herein.

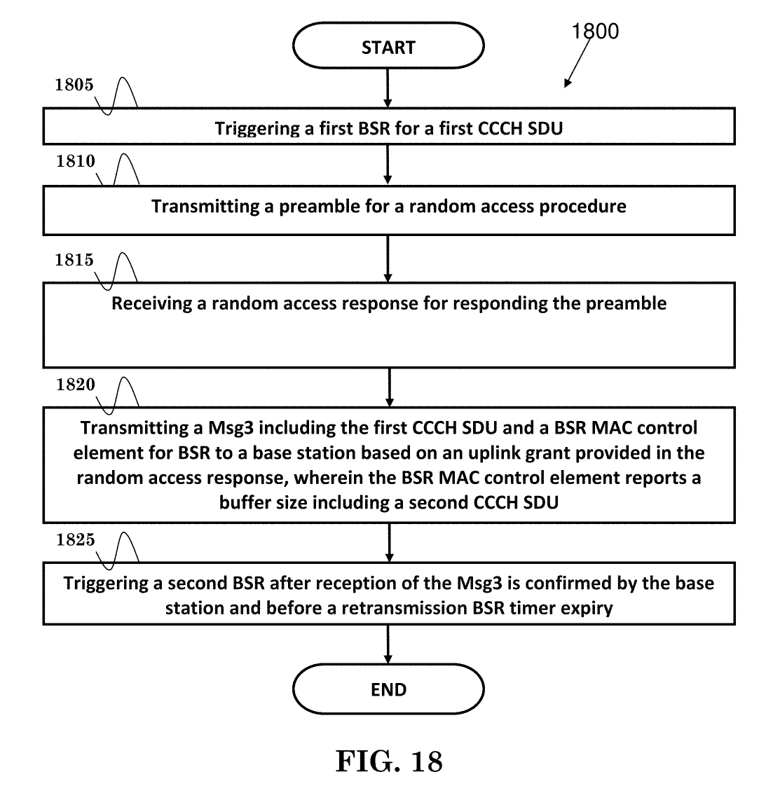

FIG. 18 is a flow chart 1800 according to one exemplary embodiment from the perspective of a UE. In step 1805, the UE triggers a first BSR for a first CCCH SDU. In step 1810, the UE transmits a preamble for a random access procedure. In step 1815, the UE receives a random access response for responding the preamble. In step 1820, the UE transmits a Msg3 including the first CCCH SDU and a BSR MAC control element for the BSR to a base station based on an uplink grant provided in the random access response, wherein the BSR MAC control element reports a buffer size including a second CCCH SDU. In step 1825, the UE triggers a second BSR after reception of the Msg3 is confirmed by the base station and before a retransmission BSR timer expiry.

In one embodiment, the MAC control element for BSR is not a MAC control element for BSR included for padding. In another embodiment, the MAC control element for BSR is a MAC control element for BSR included for padding. The first CCCH SDU could be a system information request message, and the second CCCH SDU could be a RRC connection resume request message or a RRC connection request message. The first CCCH SDU could be a RRC connection resume request message or a RRC connection request message, and the second CCCH SDU could be a system information request message.

Referring back to FIGS. 3 and 4, in one exemplary embodiment of a UE, the device 300 includes a program code 312 stored in the memory 310. The CPU 308 could execute program code 312 to enable the UE (i) to trigger a first BSR for a first CCCH SDU, (ii) to transmit a preamble for a random access procedure, (iii) to receive a random access response for responding the preamble, (iv) to transmit a Msg3 including the first CCCH SDU and a BSR MAC control element for the BSR to a base station based on an uplink grant provided in the random access response, wherein the BSR MAC control element reports a buffer size including a second CCCH SDU, and (v) to trigger a second BSR after reception of the Msg3 is confirmed by the base station and before a retransmission BSR timer expiry. Furthermore, the CPU 308 can execute the program code 312 to perform all of the above-described actions and steps or others described herein.

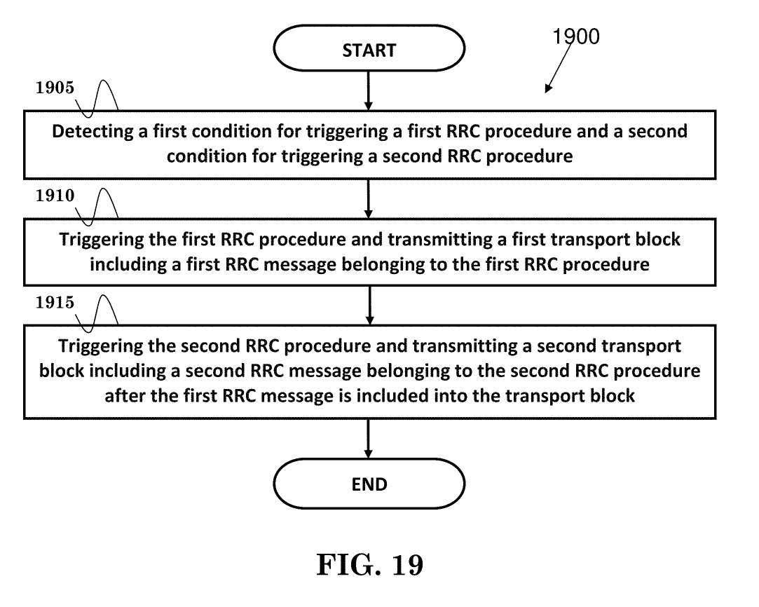

FIG. 19 is a flow chart 1900 according to one exemplary embodiment from the perspective of a UE. In step 1905, the UE detects a first condition for triggering a first RRC procedure and a second condition for triggering a second RRC procedure. In step 1910, the UE triggers the first RRC procedure and transmitting a first transport block including a first RRC message belonging to the first RRC procedure. In step 1915, the UE triggers the second RRC procedure and transmitting a second transport block including a second RRC message belonging to the second RRC procedure after the first RRC message is included into the transport block.

In one embodiment, the second RRC procedure could be triggered after the first RRC procedure is finished or after the first transport block is multiplexed. The second condition could be detected earlier than multiplexing of the first transport block.

Referring back to FIGS. 3 and 4, in one exemplary embodiment of a UE, the device 300 includes a program code 312 stored in the memory 310. The CPU 308 could execute program code 312 to enable the UE (i) to detect a first condition for triggering a first RRC procedure and a second condition for triggering a second RRC procedure, (ii) to trigger the first RRC procedure and transmitting a first transport block including a first RRC message belonging to the first RRC procedure, and (iii) to trigger the second RRC procedure and transmitting a second transport block including a second RRC message belonging to the second RRC procedure after the first RRC message is included into the transport block. Furthermore, the CPU 308 can execute the program code 312 to perform all of the above-described actions and steps or others described herein.

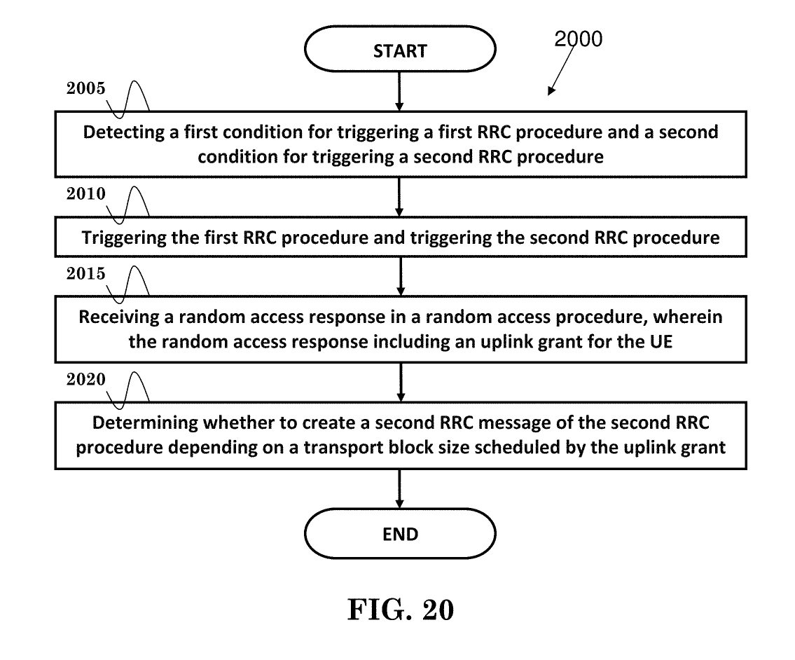

FIG. 20 is a flow chart 2000 according to one exemplary embodiment from the perspective of a UE. In step 2005, the UE detects a first condition for triggering a first RRC procedure and a second condition for triggering a second RRC procedure. In step 2010, the UE triggers the first RRC procedure and triggering the second RRC procedure. In step 2015, the UE receives a random access response in a random access procedure, wherein the random access response including an uplink grant for the UE. In step 2020, the UE determines whether to create a second RRC message of the second RRC procedure depending on a transport block size scheduled by the uplink grant.

In one embodiment, the UE could perform the random access procedure for transmitting a first RRC message of the first RRC procedure. In one embodiment, the UE could create the second RRC message if the transport block size is larger enough to accommodate both the first RRC message and the second RRC message and corresponding headers (e.g. MAC subheaders, RLC headers, or PDCP headers).

Referring back to FIGS. 3 and 4, in one exemplary embodiment of a UE, the device 300 includes a program code 312 stored in the memory 310. The CPU 308 could execute program code 312 to enable the UE (i) to detect a first condition for triggering a first RRC procedure and a second condition for triggering a second RRC procedure, (ii) to trigger the first RRC procedure and triggering the second RRC procedure, (iii) to receive a random access response in a random access procedure, wherein the random access response including an uplink grant for the UE, and (iv) to determine whether to create a second. RRC message of the second RRC procedure depending on a transport block size scheduled by the uplink grant. Furthermore, the CPU 308 can execute the program code 312 to perform all of the above-described actions and steps or others described herein.

In the context of the embodiments shown in FIGS. 19 and 20 and described above, in one embodiment, the first condition could include the UE detecting system information area identity change, the UE detecting value tag change, the UE detecting RAN notification area change, the UE detecting trackingAreaCode change, the NAS requesting a connection establishment, and/or the UE reselecting to camp on a new cell. The second condition could be include the UE detecting system information area identity change, the UE detecting value tag change, the UE detecting RAN notification area change, the UE detecting trackingAreaCode change, the NAS requesting a connection establishment, and/or the UE reselecting to camp on a new cell.

In one embodiment, the second condition could be detected earlier than receiving the random access response. The first condition could also be detected earlier than receiving the random access response.

In one embodiment, the first RRC message could be a system information request message, a RRC connection resume request message, or a RRC connection request message. The second RRC message is a system information request message, a RRC connection resume request message, or a RRC connection request message.

In one embodiment, the UE could be in RRC INACTIVE or in RRC IDLE. The UE could not be in RRC CONNECTED. The first RRC message could be a CCCH SDU. The second RRC message could also be a CCCH SDU.

In one embodiment, the first RRC procedure could be a Msg3 based system information request procedure, a RAN notification area update procedure, a tracking area update procedure, a RRC connection resume procedure, or a RRC connection request procedure. The second RRC procedure could be a Msg3 based system information request procedure, a RAN notification area update procedure, a tracking area update procedure, a RRC connection resume procedure, or a RRC connection request procedure.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a UE (User Equipment), comprising:
triggering a BSR (Buffer Status Report);
transmitting a preamble for a random access procedure;
receiving a random access response for responding the preamble;
creating a transport block based on an uplink grant provided in the random access response, wherein the transport block cannot include both a first CCCH (Common Control Channel) SDU (Service Data Unit) and a MAC (Medium Access Control) control element for BSR even if the uplink grant indicates a transport block size larger than or equal to a sum of a size of the first CCCH SDU and a size of the MAC control element for BSR; and
transmitting the transport block based on the uplink grant provided in the random access response.

2. The method of claim 1, wherein the BSR is a regular BSR.

3. The method of claim 1, wherein the BSR is not cancelled when creating the transport block.

4. The method of claim 1, wherein the BSR is not cancelled when transmitting the transport block.

5. The method of claim 1, wherein the random access procedure is triggered for the BSR.

6. The method of claim 1, wherein the transport block cannot include both the first CCCH SDU and the MAC control element for BSR if the UE has a second CCCH SDU not included into the transport block due to the transport block size indicated by the uplink grant is not enough.

7. The method of claim 1, wherein the MAC control element for BSR is not a MAC CE for BSR included for padding.

8. The method of claim 1, wherein the. MAC control element for BSR is a MAC CE for BSR included for padding.

9. The method of claim 1, wherein the BSR is triggered due to the first CCCH SDU arriving while buffer is empty.

10. A method for a UE (User Equipment), comprising:
detecting a first condition for triggering a first RRC (Radio Resource Control) procedure;
triggering the first RRC procedure and transmitting a first transport block including a first RRC message belonging to the first RRC procedure to a base station;
detecting a second condition for triggering a second RRC procedure, wherein the second condition is detected earlier than multiplexing of the first transport block; and
triggering the second RRC procedure and transmitting a second transport block including a second RRC message belonging to the second RRC procedure to the base station after the first RRC message is included into the transport block.

11. The method of claim 10, wherein the second RRC procedure is triggered after the first RRC procedure is finished.

12. The method of claim 10, wherein the second RRC procedure is triggered after the first transport block is multiplexed.

13. The method of claim 10, wherein the second condition is detected, and the first condition is detected based on same message from the base station.

14. The method of claim 10, wherein (i) the first RRC procedure is RRC connection establishment or RRC connection resume, (ii) the first condition is RAN (Radio Access Network) notification area update, tracking area update, mo-data, emergency call, mo-signaling, or nit-access, (iii) the second RRC procedure is a system information request, and (iv) the second condition is a system information area change, a system information update, or an acquiring system information.

15. The method of claim 10, wherein (i) the second RRC procedure is RRC connection establishment or RRC connection resume, (ii) the second condition is RAN notification area update, tracking area update, mo-data, emergency call, mo-signaling, or mt-access, (iii) the first RRC procedure is a system information request, and (iv) the first condition is a system information area change, a system information update, or an acquiring system information.

16. A method for a UE (User Equipment), comprising:
triggering a first BSR (Buffer Status Report) for a first CCCH (Common Control Channel) SDU (Service Data Unit);
transmitting a preamble for a random access procedure;
receiving a random access response for responding the preamble;
transmitting a Msg3 including the first CCCH SDU and a MAC control element for BSR to a base station based on an uplink grant provided in the random access response, wherein the BSR MAC control element reports a buffer size including a second CCCH SDU; and
triggering a second BSR after reception of the Msg3 being confirmed by the base station and before a retransmission BSR timer expiry.

17. The method of claim 16, wherein the MAC control element for BSR is not a MAC control element for BSR included for padding.

18. The method of claim 16, wherein the MAC control element for BSR is a MAC control element for BSR included for padding .

19. The method of claim 16, wherein the first CCCH SDU is a system information request message, and the second CCCH SDU is a RRC (Radio Resource Control) connection resume request message or a RRC connection request message.

20. The method of claim 16, wherein the first CCCH SDU is a RRC connection resume request message or a RRC connection request message, and the second CCCH SDU is a system information request message.
